(19) United States
(12) Patent Application Publication
(10) Pub. No.: US 2020/0290046 A1
(43) Pub. Date: Sep. 17, 2020

(54) MICROFLUIDIC DEVICE

(71) Applicant: THE REGENTS OF THE UNIVERSITY OF MICHIGAN, Ann Arbor, MI (US)

(72) Inventors: Ryan Castle Bailey, Ann Arbor, MI (US); Steven R. Doonan, Ann Arbor, MI (US)

(21) Appl. No.: 16/816,490

(22) Filed: Mar. 12, 2020

Related U.S. Application Data
(60) Provisional application No. 62/817,812, filed on Mar. 13, 2019.

(51) Int. Cl. B01L 3/00

(52) U.S. Cl. CPC B01L 3/502761; B01L 3/502784; B01L 2400/0415; B01L 2200/0668; B01L 2200/0631

(57) ABSTRACT

Provided herein is technology relating to microfluidics and particularly, but not exclusively, to methods, devices, and systems for solid phase sample capture and washing for continuously flowing droplet microfluidics.

This application claims priority to U.S. provisional patent application Ser. No. 62/817,812, filed Mar. 13, 2019, which is incorporated herein by reference in its entirety.

### STATEMENT REGARDING FEDERALLY SPONSORED RESEARCH OR DEVELOPMENT

This invention was made with government support under CA191186 awarded by the National Institutes of Health. The government has certain rights in the invention.

### FIELD

Provided herein is technology relating to microfluidics and particularly, but not exclusively, to methods, devices, and systems for solid phase sample capture and washing for continuously flowing droplet microfluidics.

### BACKGROUND

Droplet microfluidics have revolutionized miniaturized chemistry and biochemistry. By compartmentalizing samples in oil, two-phase segmented flow systems provide a technology for automated handling of discretized samples through complex operations at rates of up to several kHz (1-3). Individual droplets (e.g., comprising volumes of fL to nL) experience rapid mass transfer due to internal convective flows and short mixing distances, enhancing the speed and efficiency of in-droplet chemistry (2-4). By leveraging fluorinated oils and optimized surfactants, these systems provide stable droplet production, extended storage, and sophisticated manipulation to provide analogous performance compared to many bulk assays (5). Further, the power of handling large numbers of discrete, often heterogeneous sample volumes through miniaturized, rapid processing has uniquely poised droplet microfluidics at the forefront of several exciting biochemical developments. As recent examples, droplet technologies have achieved single-nucleus RNA sequencing (6), epigenetic analysis of nucleosome positioning (7), and directed enzyme evolution (8), among other implementations. See, e.g. references 2 and 9-11.

Beyond these developments, integrating solid phase sample capture and manipulation can significantly extend the capabilities of microfluidics (12-14). This class of sample processing is ubiquitous in chemistry and biochemistry, retaining selected targets on a solid phase by immobilizing antibodies or complementary oligonucleotide sequences, by manipulating surface chemistry, or by using other approaches while allowing for the exchange or washing of reagents and off-target species (15-19). Clearly, sample immobilization and washing via solid phase provides a range of important opportunities in synthesis, solid phase extraction, and analytical measurements (12). For example, a powerful bioanalytical technique, the (heterogeneous phase) immunoassay, leverages a sequence of washing and reagent exchange steps to provide the clinical standard for protein quantitation (16, 20). Failure to integrate an analogous process in droplet microfluidics will severely restrict the technology's practicality and impact.

Unfortunately for continuously flowing droplet microfluidics, a key deficiency remains. Although well-characterized strategies in a range of material systems (21) continuously and reliably form droplets and add reagents using T-junctions (22), pairwise droplet fusion (13), picoinjectors (23), and other modules (2, 3, 24, 25), approaches for selective sample capture and washing in a microfluidic device are limited. The most prevalent scheme for in-droplet sample purification combines droplet splitting with a channel-adjacent magnetic field, concentrating magnetic bead-tethered sample in only one of the daughter droplets. A range of variations on this approach have achieved limited success within a few analytical applications. Examples have demonstrated high magnetic bead recovery, removal of up to 95% of starting waste volume through droplet splitting asymmetry, or low to modest throughput (1-200 Hz droplet frequencies) (15, 24, 26-28). Nonetheless, this approach can require serial droplet splitting and reagent addition operations (with exponentially decreasing effect) to reach higher washing purity, increasing device complexity while decreasing throughput (28). Lee et al. proposed an interesting alternative: collecting magnetic beads in a washing buffer droplet during temporary fusion with the original bead-laden sample droplet (13). This was followed by nearly immediate breakup into the two original component droplets. While this device achieved approximately 25-fold dilution and bead transfer into collected droplets with little sample loss, it was also hindered by reduced throughput (3 Hz reported) and the added complexity of droplet synchronization for pairwise fusion and breakup. A breadth of solid phase manipulations in droplets have been reported (12), including strategies using microwell-based devices (29), acoustic and magnetic systems for temporary bead trapping (30, 31), and digital microfluidic (DMF) strategies (32). Such techniques, however, sacrifice the throughput and flow characteristics common to continuously flowing droplet systems. Accordingly, improvements in microfluidic washing technologies would be beneficial.

### SUMMARY

In some embodiments, the technology described herein relates to a microfluidic washing device. In some embodiments, the technology comprises use of a combination of electric and magnetic fields to fuse input droplets comprising magnetic particles with a continuous washing buffer and then re-segment new output droplets comprising washed magnetic particles from the continuous washing buffer flow. In some embodiments, the technology provides greater than 100-fold dilution of the original droplets with minimal magnetic particle loss. In some embodiments, the technology operates at processing speeds of hundreds of Hz droplet frequencies, making it compatible with the high frequencies of many other droplet operations. Experiments conducted during the development of embodiments of the technology tested the application of the technology to washing away a small molecule inhibitor to restore enzyme activity and to perform a protein enrichment and purification from cell lysate.

Thus, in some embodiments, the technology provides a microfluidic washing device comprising a coalescing component configured to coalesce an input droplet comprising a magnetic bead with a flowing wash buffer; an attracting component configured to attract magnetic beads; and a reforming component configured to reform output droplets comprising magnetic beads. In some embodiments, the coalescing component produces an electric potential. In some embodiments, the coalescing component comprises an anode and a cathode. In some embodiments, the attraction component comprises a magnet. In some embodiments, the attraction component comprises a permanent magnet. In some embodiments, the attraction component comprises an electromagnet. In some embodiments, the reforming component comprises an abrupt local decrease in channel cross section at the droplet outlet (e.g., such that dispersed phase flow rate drives stable droplet formation under typical flow conditions). In some embodiments, the technology comprises use of an additional flow focusing component to drive droplet reformation in the reforming component. For example, in some embodiments, the reforming component comprises a component configured to deliver oil flows to either side of the fluid to reform droplets.

In some embodiments, the microfluidic device further comprises a droplet inlet, a droplet outlet, a wash buffer inlet, and a wash buffer outlet.

In some embodiments, the microfluidic device comprises an oil inlet, e.g., that provides an oil to the microfluidic device (e.g., to provide an oil co-flow to prevent bead trapping at the channel wall and/or to reform output droplets at the end of the device).

In some embodiments, the coalescing component comprises an electrode at the proximal side of the device. In some embodiments, the attracting component comprises a magnet at the distal side of the device.

In some embodiments, the technology provides a microfluidic device comprising a droplet inlet near the proximal side and inlet side of the device; a wash buffer inlet near the distal side and inlet side of the device; a droplet outlet near the distal side and outlet side of the device; and a wash buffer outlet near the proximal side and outlet side of the device, wherein wash buffer flows from the wash buffer inlet to the wash buffer outlet and magnetic beads move from a proximal side to the device to a distal side of the device. In some embodiments, the microfluidic device comprises an oil inlet near the distal side and inlet side of the device, e.g., to provide an oil co-flow from the oil inlet on the inlet side to the droplet outlet on the outlet side. In some embodiments, the microfluidic device comprises a plurality (e.g., 2 or more (e.g., 2, 3, 4, 5, 6, 7, 8, 9, or 10 or more) of wash buffer inlets. In some embodiments, multiple wash buffers (e.g., having different compositions and/or different concentrations) are provided to the multiple wash buffer inlets.

In some embodiments, the technology provides methods for washing magnetic beads in a microfluidic device. In some embodiments, methods comprise coalescing an input droplet comprising a magnetic bead with a flowing wash buffer; attracting a magnetic bead; and reforming an output droplet comprising a magnetic bead. In some embodiments, coalescing comprises destabilizing said input droplet. In some embodiments, coalescing comprises providing an electric potential across said input droplet. In some embodiments, coalescing occurs near a proximal side of a microfluidic device. In some embodiments, attracting a magnetic bead comprises providing a magnetic field. In some embodiments, attracting a magnetic bead comprises providing a magnetic field using a permanent magnet or an electromagnet. In some embodiments, attracting a magnetic bead comprises providing a magnetic field at a distal side of the device. In some embodiments, attracting a magnetic bead comprises moving said magnetic bead from a proximal side of the microfluidic device to a distal side of the microfluidic device while the wash buffer flows from an inlet side of the microfluidic device to an outlet side of the microfluidic device. In some embodiments, attracting a magnetic bead comprises moving the magnetic bead into, across, and/or out of a flowing wash buffer. In some embodiments, attracting a magnetic bead comprises moving the magnetic bead into, across, and/or out of a plurality of laminarly co-flowing wash buffers (e.g., 2 or more (e.g., 2, 3, 4, 5, 6, 7, 8, 9, or 10 or more laminarly co-flowing wash buffers)).

The technology is not limited in the mechanism for flow control. In some embodiments, methods comprise providing a pressure to control flow of wash buffer. In some embodiments, methods comprise providing a pressure to control flow of droplets. In some embodiments, methods comprise providing a component for gravity-driven, vacuum-driven, and/or mechanical pump-driven (e.g., peristaltic pump, reciprocating pump, syringe pump, etc.) flow of wash buffer and/or droplets. In some embodiments, flow control is provided by a pump that supplies fluid at selected flow rates.

In some embodiments, the magnetic bead comprises a binding moiety. In some embodiments, the magnetic bead comprises a binding moiety bound to an analyte.

In some embodiments, output droplets produced by said microfluidic device comprise at least 95% of the magnetic beads present in input droplets provided to said microfluidic device. In some embodiments, output droplets produced by said microfluidic device comprise at least 95% of the analyte present in input droplets provided to said microfluidic device. In some embodiments, non-analytes in output droplets produced by said microfluidic device are diluted 100-fold to 1000-fold relative to input droplets provided to said microfluidic device. In some embodiments, the microfluidic device processes droplets at greater than 100 Hz.

In some embodiments, methods comprise accepting input droplets at a droplet inlet. In some embodiments, methods comprise producing output droplets at a droplet outlet.

In some embodiments, the technology provides systems. In some embodiments, systems comprise a microfluidic washing device as described herein, e.g., comprising a coalescing component configured to coalesce an input droplet comprising a magnetic bead with a flowing wash buffer; an attracting component configured to attract magnetic beads; and a reforming component configured to reform output droplets comprising magnetic beads. In some embodiments, systems further comprise a second microfluidic device in fluid communication with said microfluidic washing device. In some embodiments, the second microfluidic device is a microfluidic washing device. In some embodiments, systems further comprise a computer. In some embodiments, systems further comprise a source of wash buffer. In some embodiments, systems further comprise a detection means. In some embodiments, systems further comprise a data storage component, a data transmission component, and/or a display. In some embodiments, systems comprise a pressure or fluid flow controller.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings:

FIG. 1 is a schematic drawing showing an embodiment of the technology described herein. In the embodiment shown, the microfluidic device receives input droplets (e.g., 60) at a droplet inlet (10). The microfluidic device electrocoalesces input droplets (e.g., 60) using an electric field applied across the flowing wash buffer stream provided by a wash buffer inlet (90). The electric field is provided by an electrode in the flowing wash buffer (40a) and a nearby ground electrode (40b). Next, a channel-adjacent magnet (30) attracts sample-enriched magnetic beads (e.g., 80) across the buffer stream while flow forces confine waste material to the original streamline that is output at the wash buffer outlet (50). In some embodiments, an oil co-flow prevents bead trapping at the channel wall and, at the end of the module, reforms output droplets (e.g., 70) in washing buffer for output at the drop outlet (20), e.g., for further manipulations. The proximal side 100, distal side 200, inlet side 300, and outlet side 400 of the device are indicated at the top, bottom, left, and right of the schematic drawing, respectively.

FIGS. 2A to 2C show data demonstrating operation of the microfluidic washing technology described herein. FIG. 2A: Micrograph of the module coalescing and reforming droplets at greater than 500 Hz each. Electric field was applied across the PBS washing buffer to the adjacent grounded saline electrode channel. 10-μm magnetic beads are visible as small, black particles, and flow is generally left to right. FIG. 2B: Loading input droplets with 1-mM fluorescein enables localization of free waste material from input droplets. FIG. 2C: Plotting the intensity of the channel cross-section prior to the bifurcation (region of interest indicated by the white box in the previous image) demonstrates that the fluorescent signal from waste material is statistically indistinguishable from a 100-fold diluted fluorescein standard at position=50 μm (channel bifurcation occurs at position=120 μm).

FIGS. 3A-3E show data collected during experiments to test alternative magnetic particles. FIG. 3A: Extending the magnetic capture region increases the utility of some embodiments of the module for particles with lower magnetic loading. Boxes indicate regions of interest shown in the following figures. FIG. 3B: Micrograph of the module coalescing input droplets at approximately 250 Hz. Electric field was applied across the PBS washing buffer to the adjacent grounded saline electrode channel. 2.8-μm magnetic Dynabeads are evident as small, black particles in high abundance, and flow is generally left to right. FIG. 3C: High magnification micrograph of the module reforming droplets downstream at approximately 200 Hz with efficient Dynabead recovery, stabilized by an additional flow focusing structure. FIG. 3D: Loading input droplets with 1-mM fluorescein enables localization of free waste material from input droplets. FIG. 3E: Plotting the intensity of the channel cross-section prior to the bifurcation (region of interest indicated by the box in the previous image) demonstrates that the fluorescent signal from waste material is statistically indistinguishable from a 100-fold diluted fluorescein standard at position=60 μm (channel bifurcation occurs at position=120 μm).

FIG. 4A-4E show data collected from experiments testing removal of a small molecule inhibitor by embodiments of the technology. FIG. 4A: Droplets containing bead-bound 6-galactosidase incubated with 1-mM IPTG were washed into PBS and resorufin-6-D-galactopyranoside substrate using the microfluidic washing device. Droplets were imaged on the Detection Channel device after approximately 20 seconds of dynamic incubation using a 4-cm Incubation Loop of connecting tubing. The box indicates the region of interest for subsequent figures. FIG. 4B: Inhibitor-free control droplets (IPTG neither in original sample droplets nor in final washing buffer with substrate) generated fluorescent resorufin product. Droplets with higher bead loadings typically gave greater signal. FIG. 4C: IPTG-containing sample droplets were washed into IPTG-free washing buffer with substrate. Comparable fluorescent product formation relative to the inhibitor-free control indicates inhibitor removal by washing. FIG. 4D: Inhibited control droplets (IPTG both in original sample droplets and in final washing buffer with substrate) generated little fluorescent product. FIG. 4E: Measuring the fluorescence of only single bead droplets (outlined in circles) confirmed that washing fully recovered activity in the originally inhibited system (FIG. 4C) compared to uninhibited and inhibited controls (FIGS. 4B and 4D, respectively). The inhibited control (FIG. 4D) differed significantly in intensity from the other conditions.

FIGS. 5A-5F show data from experiments testing selective enrichment of GFP-H2B from cell lysate. FIG. 5A: Anti-GFP antibody-functionalized beads were pre-emulsified into droplets at approximately 4 kHz to limit sedimentation. FIG. 5B: The bead emulsion was injected into HeLa cell lysate droplets with added mCherry. FIG. 5C: After 1 hour of off-chip incubation, droplets were processed using an embodiment of the microfluidic washing device described herein. Flow was generally left to right in FIGS. 5A-4C. FIG. 5D: Droplet populations were fluorescently imaged in green and red channels under static conditions including the functionalized bead emulsion (Anti-GFP Beads), the sample droplets with beads and lysate after incubation but prior to washing (Pre-Wash), and the final sample droplets with beads after washing (Post-Wash). Beads are visible in each panel as bright spots. FIG. 5E: For the green fluorescent channel, the Pre-Wash population was significantly brighter than the original Anti-GFP Beads, indicating the presence of GFP-H2B. Similarly, the Post-Wash population was significantly brighter than the original Anti-GFP Beads, demonstrating enrichment and retention of GFP-H2B after washing. The Post-Wash population was slightly, but significantly, less bright than the Pre-Wash population, suggesting incomplete GFP-H2B recovery. FIG. 5F: For the red fluorescent channel, the Pre-Wash population was significantly brighter than the original Anti-GFP Beads due to the presence of mCherry added to the cell lysate. Importantly, the Post-Wash population was not significantly brighter than the original Anti-GFP Beads, indicating mCherry removal by washing.

FIG. 6 shows a schematic drawing of an exemplary microfluidic device as described herein that is specialized for 10-μm magnetic particles. a) Saline electrolyte channel 1 inlet. b) Saline electrode channel 1 outlet. c) Washing buffer inlet. d) Oil co-flow inlet. e) Droplet inlet. f) Saline electrode channel 2 outlet. g) Saline electrode channel 2 inlet. h) Washing buffer and droplet waste outlet. i) Droplet/be ad/analyte outlet. j) Magnet alignment and positioning features. k) 2-mm scale bar.

FIG. 7 shows a schematic drawing of an exemplary microfluidic device as described herein that is specialized for 2.8-μm magnetic particles. a) Saline electrolyte channel 1 inlet. b) Saline electrode channel 1 outlet. c) Washing buffer inlet. d) Oil co-flow inlet. e) Saline electrode channel 2 outlet. f) Droplet inlet. g) Saline electrode channel 2 inlet. h) Washing buffer and droplet waste outlet. i) Oil inlet for flow focusing-stabilized droplet resegmentation. j) Droplet/bead/analyte outlet. k) Magnet alignment and positioning features. l) 2 mm scale bar.

FIG. 8 shows a schematic drawing of a microfluidic device as described herein that comprises multiple washing buffers (e.g., provided in a laminarly co-flowing configuration). The beads are washed sequentially by the multiple flowing wash buffers (e.g., by laminar co-flow from a plurality of wash buffer inlets to the wash buffer outlet) as the beads move from the proximal side to the distal side. a) Saline electrolyte channel 1 inlet. b) Saline electrode channel 1 outlet. c) Washing buffer 1 inlet. d) Washing buffer 2 inlet. e) Washing buffer 3 inlet. f) Washing buffer 4 inlet. g) Oil co-flow inlet. h) Droplet inlet. i) Saline electrode channel 2 outlet. j) Saline electrode channel 2 inlet. k) Washing buffer and droplet waste outlet. l) Droplet/bead/analyte outlet. m) Magnet alignment and positioning features. n) 2-mm scale bar.

FIG. 9 shows a micrograph of a microfluidic device as described herein that comprises multiple laminarly co-flowing wash buffers. The technology comprises coalescing input droplets, magnetically attracting magnetic beads across four (e.g., four different) washing buffers, and resegmenting droplets in the final washing buffer. b) Fluorescent micrograph of operation shows the position of each washing buffer (washing buffer 1 and washing buffer 3 have added fluorescent components for ease of visualization). Arrows highlight bead positions in each image.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to microfluidics and particularly, but not exclusively, to methods, devices, and systems for solid phase sample capture and washing for continuously flowing droplet microfluidics.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the term “microfluidic device” refers to a device comprising fluidic structures and internal channels having microfluidic dimensions. These fluidic structures may include chambers, valves, vents, vias, pumps, inlets, nipples, and detection means, for example. Generally, microfluidic channels are fluid passages having at least one internal cross-sectional dimension that is less than approximately 500 μm to 1000 μm and typically between approximately 0.1 μm and approximately 500 μm. The microfluidic flow regime is characterized by “Poiseuille” or “laminar” flow (see, e.g., Staben et al. (2005) “Particle transport in Poiseuille flow in narrow channels” Intl J Multiphase Flow 31: 529-47, incorporated herein by reference).

As used herein, the term “microfluidic channel” or “microchannel” refers to a fluid channel having variable length and one dimension in cross-section that is less than 500 to 1000 μm. Microfluidic fluid flow behavior in a microfluidic channel is highly non-ideal and laminar and may be more dependent on wall wetting properties, roughness, liquid viscosity, adhesion, and cohesion than on pressure drop from end to end or cross-sectional area. The microfluidic flow regime is often associated with the presence of “virtual liquid walls” in the channel. However, in larger channels, head pressures of 10 psi or more can generate transitional flow regimes bordering on turbulent flow, as can be important in rinse steps of assays.

As used herein, the term “via” refers to a step in a microfluidic channel that provides a fluid pathway from one substrate layer to another substrate layer above or below, characteristic of laminated devices built from layers.

As used herein, the term “waste” refers to a discharged sample, a rinse solution, waste reagents, etc., e.g., comprising non-analyte components.

As used herein a “vent” refers to a pore intercommunicating between an internal cavity and the atmosphere. In some embodiments, a vent comprises a filter element that is permeable to gas but is hydrophobic and resists wetting. Optionally these filter elements have pore diameters of 0.45 micrometers or less. Filter elements of this type and construction may also be placed internally, for example to isolate a valve or bellows pump from the pneumatic manifold controlling it.

As used herein, the term “means for a function” indicates that the scope of the technology encompasses all means for performing the function that are described herein and all other means commonly known in the art at the time of filing.

As used herein, the term “means for detecting” or “detection means” refers to an apparatus for monitoring a signal and/or displaying signal value, e.g., to monitor the progress of an assay and/or to determine a result of an assay. A detection means may include a detection channel and a means for evaluation of a signal value. A signal may be detected and/or evaluated by an observer visually or by a machine equipped with a detection means such as a spectrophotometer, fluorometer, luminometer, photomultiplier tube, photodiode, nephlometer, photon counter, voltmeter, ammeter, pH meter, capacitative sensor, radio-frequency transmitter, magnetoresistometer, or Hall-effect device. Magnetic particles, beads, and microspheres having color or impregnated with color or having a higher diffraction index may be used to facilitate visual or machine-enhanced detection of a signal. Magnifying lenses, optical filters, colored fluids, and labeling may be used to improve detection and interpretation of a signal. Means for detection may also include the use of “labels” or “tags” such as, but not limited to, dyes such as chromophores and fluorophores, radio frequency tags, plasmon resonance, spintronic, radiolabel, Raman scattering, chemoluminescence, or inductive moment as are known in the art. Fluorescence quenching signals are also included. A variety of substrate and product chromophores associated with biochemical enzyme assays are also well known in the art and, in some embodiments, provide a means for amplifying a signal so as to improve sensitivity of detection. In some embodiments, detection comprises use of a radionuclide detection system. Detection means or systems are optionally qualitative, quantitative, or semi-quantitative. Visual detection is preferred for its simplicity; however, detection means can involve visual detection, machine detection, manual detection, or automated detection.

As used herein, the term “bead” refers to a particle. The bead may be a solid or semi-solid particle. The bead may be a gel. The bead may be formed of a polymeric material. The bead may be magnetic or non-magnetic. In some embodiments, the bead is a particle that is capable of interacting with a fluid. In some embodiments, the fluid is in the form of a droplet and the bead is capable of being incorporated into a droplet. Beads may be any of a wide variety of shapes, such as spherical, generally spherical, egg shaped, disc shaped, cubical, and other three-dimensional shapes. The bead may, for example, be capable of being transported in a fluid (e.g., a droplet) or otherwise configured in a manner that permits a fluid (e.g., a droplet) to be brought into contact with the bead. In some embodiments, a bead comprises a “binding moiety”, e.g., that is attached, linked, bonded, and/or associated with the bead.

As used herein, the term “binding moiety” refers to any entity (e.g., molecule, biomolecule, etc.) that recognizes an analyte (e.g., binds to an analyte, e.g., binds specifically to an analyte) and links the analyte to a bead such that the analyte and bead are stably associated. Accordingly, the binding moiety bound to a magnetic bead will depend on the nature of the analyte targeted. In some embodiments, the beads comprise binding moieties, including, but not limited to, antibodies, Fc fragments, Fab fragments, lectins, polysaccharides, receptor ligands, DNA sequences, PNA sequences, siRNA sequences, or RNA sequences. Further examples of binding moieties include, without limitation, proteins (such as antibodies, avidin, and cell-surface receptors), charged or uncharged polymers (such as polypeptides, nucleic acids, and synthetic polymers), hydrophobic or hydrophilic polymers, small molecules (such as biotin, receptor ligands, and chelating agents), carbohydrates, and ions. Such capture moieties can be used to specifically bind cells (e.g., bacterial, pathogenic, fetal cells, fetal blood cells, sperm cells, cancer cells, and blood cells), organelles (e.g., nuclei), viruses, peptides, proteins, carbohydrates, polymers, nucleic acids, supramolecular complexes, other biological molecules (e.g., organic or inorganic molecules), small molecules, ions, or combinations (chimera) or fragments thereof. In some embodiments binding moieties can be bound to magnetic beads by any means known in the art. Examples include chemical reaction, physical adsorption, entanglement, or electrostatic interaction.

The beads may be any suitable size, including for example, microbeads, microparticles, nanobeads, and nanoparticles. In some embodiments the magnetically responsive beads have dimensions smaller than 600 nm, such as 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, 40 nm, 30 nm, 20 nm, or 10 nm. In some embodiments, a magnetic bead has a diameter that is between 10-1000 nm, 20-800 nm, 30-600 nm, 40-400 nm, or 50-200 nm. In some embodiments, a magnetic bead has a diameter of more than 10 nm, 50 nm, 100 nm, 200 nm, 500 nm, 1000 nm, or 5000 nm.

In some embodiments, the beads have a diameter of approximately 0.1 μm to 100 μm (e.g., 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 μm). In some embodiments, the beads have a diameter of approximately 2 μm to 3 μm (e.g., 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, or 3.00 μm). In some embodiments, the beads have a diameter of approximately 5 to 20 μm (e.g., 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, 12.0, 12.2, 12.4, 12.6, 12.8, 13.0, 13.2, 13.4, 13.6, 13.8, 14.0, 14.2, 14.4, 14.6, 14.8, 15.0, 15.2, 15.4, 15.6, 15.8, 16.0, 16.2, 16.4, 16.6, 16.8, 17.0, 17.2, 17.4, 17.6, 17.8, 18.0, 18.2, 18.4, 18.6, 18.8, 19.0, 19.2, 19.4, 19.6, 19.8, or 20.0 μm).

Beads may be manufactured using a wide variety of materials, including for example, resins and polymers. According to embodiments of the technology, beads are magnetically responsive. For magnetically responsive beads, the magnetically responsive material may constitute substantially all of a bead or one component only of a bead. The remainder of the bead may include, among other things, polymeric material, coatings, and moieties that permit attachment of an assay reagent.

As used herein, the terms “magnetic particles” and “magnetic beads” are used interchangeably and refer to particles or beads that respond to a magnetic field. Typically, magnetic particles comprise materials that have no magnetic field but that form a magnetic dipole when exposed to a magnetic field, e.g., materials capable of being magnetized in the presence of a magnetic field but that are not themselves magnetic in the absence of such a field. The term “magnetic” as used in this context includes materials that are paramagnetic or superparamagnetic materials. The term “magnetic”, as used herein, also encompasses temporarily magnetic materials, such as ferromagnetic or ferrimagnetic materials with low Curie temperatures, provided that such temporarily magnetic materials are paramagnetic in the temperature range at which silica magnetic particles containing such materials are used according to the present methods to isolate biological materials. Examples of suitable magnetically responsive beads are described in U.S. Patent Publication No. 2005/0260686, incorporated herein by reference. Examples of droplet manipulation techniques for immobilizing magnetically responsive beads and/or conducting droplet operations protocols using beads are described in U.S. patent application Ser. No. 11/639,566; International Patent Application No. PCT/US2008/053545; International Patent Application No. PCT/US2008/058018; International Patent Application No. PCT/US2008/058047; International Patent Application No. PCT/US2006/047486; and U.S. Pat. No. 8,637,324, each of which is incorporated herein by reference. In some embodiments, magnetic beads comprise approximately 10 to 30% magnetite (e.g., approximately 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, or 30.0% magnetite).

As used herein, the term “magnetically responsive” refers to the characteristic of being responsive to a magnetic field. As used herein, the term “magnetically responsive beads” or “magnetic beads” refer to beads that include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄ (e.g., magnetite), BaFe₁₂O₁₉, CoO, NiO, Mn₂O₃, Cr₂O₃, and CoMnP. Magnetic beads for affinity capture and bead capture devices are readily available, for example from: Dynal Biotech ASA, Oslo, Norway (see, e.g., U.S. Pat. No. 4,654,267, incorporated herein by reference); BD Biosciences, San Jose Calif.; and New England Biolabs, Beverly, Mass., among others.

As used herein, the term “droplet” refers to a volume of liquid that is at least partially bounded by another (e.g., filler or “co-flow”) fluid. For example, a droplet may be completely surrounded by co-flow fluid or may be bounded by co-flow fluid and one or more surfaces of a microfluidic device or non-microfluidic device that produces and/or processes droplets. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a device for manipulating droplets. For examples of droplets and devices for forming and/or manipulating droplets, see U.S. Pat. No. 6,911,132; U.S. patent application Ser. No. 11/343,284; U.S. Pat. Nos. 6,773,566 and 6,565,727; International Patent Application No. PCT/US2006/047486, International Patent Application No. PCT/US2016/069579, each of which is incorporated herein by reference. In some embodiments, droplets are manipulated using droplet actuator systems, e.g., as described in International Patent Application No. PCT/US2007/009379.

As used herein, the term “droplet operation” refers to any manipulation of a droplet. A droplet operation may, for example, include: loading a droplet into a microfluidic device; dispensing one or more droplets from a source of droplets; splitting, separating, or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; condensing a droplet from a vapor; cooling a droplet; disposing of a droplet; transporting a droplet out of a microfluidic device; other droplet operations described herein; and/or any combination of the foregoing. The terms “merge”, “merging”, “combine”, “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (e.g., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. In various embodiments, the droplet operations may be electrode mediated, e.g., electrowetting mediated or dielectrophoresis mediated.

As used herein, the term “filler fluid” and “co-flow fluid” are used to refer to a fluid that is sufficiently immiscible with a droplet phase. The co-flow fluid may, for example, be a low-viscosity oil, such as silicone oil. In some embodiments, the co-flow fluid comprises a surfactant (e.g., a fluorosurfactant) that changes properties of the co-flow and/or the droplets in useful ways (e.g., in some embodiments, droplets are stabilized by a surfactant in the co-flow fluid). Other examples of co-flow fluids are provided in International Patent Application No. PCT/US2006/047486 and in International Patent Application No. PCT/US2008/072604, each of which is incorporated herein by reference. In some embodiments, the co-flow fluid (e.g., oil) comprises a surfactant and/or a fluorosurfactant (e.g., in the co-flow stream and/or in co-flow fluid bounding the original input sample droplets). Surfactants organize at the co-flow fluid phase-droplet phase interface and excess surfactant molecules remain in the co-flow fluid phase.

As used herein, the term “washing” with respect to washing a magnetic bead refers to reducing the amount and/or concentration of one or more substances in contact with the magnetic bead or exposed to the magnetic bead from a droplet in contact with the magnetic bead. The reduction in the amount and/or concentration of the substance may be partial, substantially complete, or complete. The substance may be any of a wide variety of substances (e.g., target substances for further analysis or unwanted substances, such as components of a sample, contaminants, and/or excess reagent). In some embodiments, a washing operation begins with an input droplet comprising a magnetic bead, where the droplet includes an initial amount and initial concentration of a substance. The washing operation may proceed using a variety of droplet operations. The washing operation may yield an output droplet comprising the magnetic bead, where the droplet has a total amount and/or concentration of the substance that is less than the initial amount and/or concentration of the substance.

As used herein, when a liquid in any form (e.g., a droplet or a continuous body, whether moving or stationary) is described as being “on”, “at”, or “over” an electrode, array, magnet, or surface, such liquid may be either in direct contact with the electrode, array, magnet, or surface or could be in contact with one or more layers or films that are interposed between the liquid and the electrode, array, magnet, or surface.

As used herein, the terms “associated with a bead” or “captured by a bead” refers to capture of an analytes from a sample by, e.g., hydrogen bonding, hydrophobic bonding, and Van der Waal's forces, and is influenced by salt and solute concentrations, zeta potential, dielectric constant of the solvent, temperature, cooperative binding, and the like. Under certain reaction conditions, capture may be covalent, such as in the interaction of metal chelates with histidine.

### DESCRIPTION

Embodiments of the technology provided herein combine simple, robust operation with high throughput and efficiency. Thus, embodiments of the microfluidic washing technology provide an improved technology for solid phase-mediated sample processing. Experiments were conducted during the development of embodiments of the technology to characterize performance of the technology in terms of bead loss and final droplet dilution for selected magnetic particles and flow conditions. Data collected indicated excellent bead recovery and buffer exchange. Further, experiments were conducted during the development of embodiments of the technology to test recovering enzyme activity by washing away a small molecule inhibitor and to test selectively enriching a target fluorescent protein from cell lysate. The technology improves droplet microfluidics by narrowing the technological gap between pre-existing droplet methodologies and important (bio)chemical techniques comprising use of solid supports (e.g., beads). The technology finds use in a breadth of downstream technologies capable of high throughput, miniaturized analogs for immunoassays, solid phase extraction, and more. Although the disclosure herein refers to certain illustrated embodiments, it is to be understood that these embodiments are presented by way of example and not by way of limitation.

### Microfluidic Devices

Microfluidic technologies provide many advantages (see, e.g., S. R. Quake and A. Scherer, “From Micro to Nano Fabrication with Soft Materials,” Science, vol. 290, pp. 1536-40, 2000). Generally, microfluidic devices handle small amounts of fluids, e.g., droplets having volumes of 1-1000 μL, 1-1000 nL, 1-1000 pL, or 1-1000 fL (e.g., 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 μL, nL, pL, or fL). Microfluidic devices typically have a small size and consume small amounts of reagents and energy. Finally, advantages of the technology are related to the behavior of small volumes of fluids with the microstructures of a microfluidic device. See, e.g., Squires and Quake (2005), “Microfluidics: Fluid physics at the nanoliter scale”. Reviews of Modern Physics 77: 977, incorporated herein by reference in its entirety.

For example, the microfluidic technologies described herein provide a technology for washing samples (e.g., analytes) associated (e.g., bound, tethered, etc.) to a bead. In some embodiments, the high surface-to-volume ratio of microfluidic devices dramatically reduces reaction times. Moreover, microfluidic devices provide for precise fluid handling. And, finally, microfluidics allows one to manipulate and to run parallel tests on a single small device.

In some embodiments of the technology provided herein, microfabrication techniques are used to produce a microfluidic device. For example, in some embodiments a microfluidic device is produced by a method comprising replica molding using soft lithography methods. In some embodiments, replica molding using soft lithography comprises producing microfluidic platforms from polydimethylsiloxane (PDMS). PDMS is a silicon rubber that provides advantages related to fabrication, physical properties, and economy (see, e.g., J. Friend and L. Yeo. “Fabrication of microfluidic devices using polydimethylsiloxane,” Biomicrofluidics, vol. 4, pp: 026502, 2010). PDMS microfluidic platforms have further advantages related to transparency, gas permeability, and chemical stability (e.g., chemical inertness).

In various embodiments, microfluidic devices are fabricated from various materials using techniques such as laser stenciling, embossing, stamping, injection molding, masking, etching, and three-dimensional soft lithography. Laminated microfluidic devices are further fabricated with adhesive interlayers or by thermal adhesiveless bonding techniques, such as by pressure treatment of oriented polypropylene. The microarchitecture of laminated and molded microfluidic devices can differ.

In some embodiments, microchannels are constructed of layers formed by extrusion molding. The flow characteristics of microchannels are significant because of the surface effects in the microflow regime. Surface tension and viscosity influence (e.g., enhance) surface roughness effects. In some embodiments, the narrowest dimension of a channel has the most profound effect on flow. Flow in channels that have rectangular or circular cross-sectional profiles is controlled by the diagonal width or diameter; thus, in some embodiments, channel design is typically varied to take advantage of this behavior. In some embodiments, reduction of taper in the direction of flow leads to a wicking effect for diameters below 200 micrometers. Conversely, flow can be stopped by opening a channel to form a bulb; then, flow can be restored by applying a pressure. Vias in a channel can be designed to promote directional flow, e.g., to provide a type of solid-state check valve.

In some embodiments, microfluidic devices described herein are fabricated from an elastomeric polymer such as, e.g., polyisoprene, polybutadiene, polychlorophene, polyisobutylene, poly(styrene-butadiene-styrene), nitriles, polyurethanes, or polysilicones. In some embodiments, GE RTV 615, a vinyl-silane crosslinked (type) silicone elastomer (family) or polydimethysiloxane (PDMS) (e.g., sold as HT-6135 and HT-6240 from Bisco Silicons, Elk Grove, Ill.) is useful. The choice of materials typically depends upon the particular material properties (e.g., solvent resistance, stiffness, gas permeability, and/or temperature stability) required for the application being conducted. In some embodiments, elastomeric materials that are used in the manufacture of components of the microfluidic devices are described in Unger (2000) Science 288:113-116, incorporated herein by reference in its entirety. Some elastomers of the present devices are used as diaphragms. In some embodiments, elastomers are selected for their porosity, impermeability, chemical resistance, wetting, and passivating characteristics in addition to their stretch and relax properties. In some embodiments, an elastomer is selected for its thermal conductivity. For example, Micrometrics Parker Chomerics Therm A Gap material 61-02-0404-F574 (0.020″ thick) is a soft elastomer (<5 Shore A) needing only a pressure of 5 to 10 psi to provide a thermal conductivity of 1.6 W/m·K.

### Microfluidic Washing Device

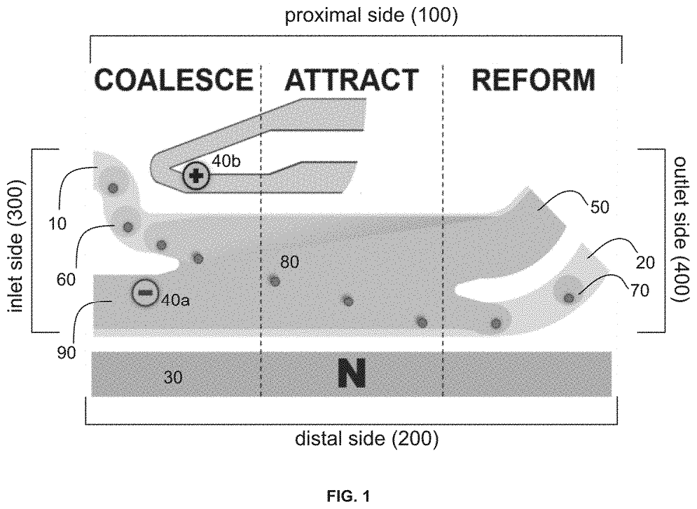

Embodiments of the microfluidic washing device comprise a coalescing component, an attracting component, and a reforming component (see FIG. 1). In some embodiments, the microfluidic washing device provided herein, e.g., as shown in FIG. 1, comprises a droplet inlet 10 (e.g., for receiving input droplets 60 comprising a magnetic bead (shown as smaller grey circles in FIG. 1 (e.g., 80)), a droplet outlet 20 (e.g., for providing output droplets 70 comprising a magnetic bead after washing), a source of an electric potential (e.g., electrodes 40a and 40b), and a source of a magnetic field 30. In some embodiments, the microfluidic device also comprises a wash buffer. In some embodiments, the microfluidic device comprises a wash buffer inlet 90 and a wash buffer (e.g., waste) outlet 50. In some embodiments, the microfluidic device comprises an oil inlet (e.g., on the inlet side of the device), e.g., for providing a co-flow fluid to the microfluidic device.

As shown in FIG. 1, in some embodiments, the microfluidic device comprises a proximal side 100 and a distal side 200. In some embodiments, the microfluidic device comprises an inlet side 300 and an outlet side 400.

In some embodiments, the inlet side 300 comprises the droplet inlet 10 toward the proximal side 100 of the microfluidic device; and the inlet side 300 comprises the wash buffer inlet 90 toward the distal side 200 of the microfluidic device. In some embodiments, the outlet side 400 comprises the droplet outlet 20 toward the distal side 200 of the microfluidic device; and the outlet side 400 comprises the wash buffer outlet 50 toward the proximal side 100 of the microfluidic device.

In some embodiments, the source of a magnetic field 30 is provided on the distal side 200 of the microfluidic device. In some embodiments, the source of an electric potential comprises a component (e.g., an electrode 40b) provided on the proximal side 100 of the microfluidic device and a component (e.g., an electrode 40a) placed in the flowing wash buffer.

Embodiments of the technology apply an electric potential to destabilize input droplets to promote coalescence of droplets with a wash buffer. The technology is not limited in the component that provides the electric potential. For example, in some embodiments, the electric potential is provided by a pair of electrodes (e.g., a cathode and an anode). In some embodiments, the electric potential is between 10 and 100 V alternating current (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 Volts AC). In some embodiments, the voltage is higher than 100 VAC provided that the microfluidic device material is appropriate for the voltage. For example, in some embodiments, the voltage is between 100 and 1000 VAC (e.g., 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or1000 VAC).

In some embodiments, a first electrode is positioned within the flowing wash buffer and a second electrode is a ground (e.g., not positioned within the flowing wash buffer).

The technology is not limited in the technology used to coalesce droplets with the wash buffer. In some embodiments, other approaches find use to coalesce droplets with the wash buffer, e.g., alone or in combination with the electrodes used for coalescence as described herein. In some embodiments, a chemical method is used to coalesce droplets with the wash buffer (e.g., a destabilizing agent in a fluid is added to the channel containing the droplets to coalesce the droplets with each other and with the wash buffer).

Embodiments of the technology apply a magnetic field to move magnetic particles (e.g., from the proximal side to the distal side as flow moves from the inlet side to the outlet side; see FIG. 1). The technology is not limited in component that comprises the source of the magnetic field. Accordingly, such a magnetic field can be suitably generated using any one of a number of different known means. For example, one can position a magnet (or a plurality of magnets) next to the flow channel comprising magnetic particles, causing the particles to migrate across the flow channel toward the outlet. In some embodiments, the magnet is a permanent magnet. In some embodiments, the magnet is an electromagnet. In some embodiments, the magnetic field has a magnetic flux density of approximately 5 to 25 kG (e.g., 5, 6, 7, 8, 9, 10, 11, 12, 13, 14, 15, 16, 17, 18, 19, 20, 21, 22, 23, 24, or 25 kG).

Embodiments of the technology comprise a reforming component comprising an abrupt local decrease in channel cross section at the droplet outlet (e.g., such that dispersed phase flow rate drives stable output droplet formation under typical flow conditions). In some embodiments, the technology comprises use of an additional flow focusing component to drive droplet reformation in the reforming component. For example, in some embodiments, the reforming component comprises a component configured to deliver oil flows to either side of the fluid to reform droplets.

In some embodiments, the wash buffer comprises tris(hydroxymethyl)aminomethane (TRIS), N-(tri(hydroxymethyl)methyDglycine (Tricine), N,N-bis(2-hydroxyethyl)glycine (BICINE), N-(2-hydroxyethyDpiperazine-N′-(2-ethanesulphonic acid) (HEPES), piperazine-1,4-bis(2-ethanesulphonic acid) (PIPES), N-cyclohexyl-2-aminoethanesulphonic acid (CHES), 2-(N-morpholino)ethanesulphonic acid (MES), 3-(N-morpholino)propanesulphonic acid (MOPS), and/or phosphate buffer (e.g., comprising a phosphate salt such as a dihydrogen phosphate (e.g., potassium dihydrogen phosphate (KH₂PO₄) or sodium dihydrogen phosphate (NaH₂PO₄)) or a hydrogen phosphate (e.g., disodium hydrogen phosphate dihydrate (Na₂HPO₄.2H₂O) or dipotassium hydrogen phosphate)), mixtures of phosphate salts, or PBS (phosphate buffered saline), which comprises sodium chloride, Na₂HPO₄, potassium chloride, and KH₂PO₄. In some embodiments, the wash buffer comprises a surfactant (e.g., a detergent) such as, e.g., TWEEN, Triton, Brij, CHAPS, CHAPSO, or other nonionic or ionic (e.g., cationic or anionic) surfactant.

In some embodiments, the frequency of droplet input and/or droplet output are greater than 100 Hz (e.g., greater than 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, the frequency of droplet input and/or droplet output are greater than 250 Hz (e.g., greater than 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, the frequency of droplet input and/or droplet output are greater than 500 Hz (e.g., greater than 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, the frequency of droplet input and/or droplet output are in the range of 100-1000 Hz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz). In some embodiments, the frequency of droplet input and/or droplet output are in the range of 250-1000 Hz (e.g., 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz). In some embodiments, the frequency of droplet input and/or droplet output are in the range of 500-1000 Hz (e.g., 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz).

In some embodiments, the device operates at a slower frequency, e.g., 0.1-10 Hz. (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 Hz) or 10-100 Hz (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 Hz).

In some embodiments, the input and output frequencies are the same or essentially the same. In some embodiments, the input and output frequencies are within 5-10% (e.g., 5.0, 5.5, 6.0, 6.5, 7.0, 7.5, 8.0, 8.5, 9.0, 9.5, 10.0) of one another. In some embodiments, the input and output frequencies are different or essentially different. In some embodiments, the input and output frequencies are different by more than 1-10% (e.g., 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0%).

In some embodiments, the microfluidic device provides greater than 95% bead recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%). In some embodiments, the microfluidic device provides greater than 95% analyte recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%).

In some embodiments, output droplets are diluted relative to input droplets approximately more that 10-fold (e.g., more than 10, 15, 20, 25, 30, 35, 40, 45, 50, 55, 60, 65, 70, 75, 80, 85, 90, 95, or 100-fold). In some embodiments, output droplets are diluted relative to input droplets approximately more than 50-fold (e.g., more than 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold). In some embodiments, output droplets are diluted relative to input droplets approximately more than 100-fold (e.g., more than 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, or 1000-fold). In some embodiments, output droplets are diluted relative to input droplets approximately 50-fold to 500-fold (e.g., 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold).

In some embodiments, the microfluidic device provides greater than 95% bead and/or analyte recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%); and the output droplets are diluted relative to input droplets approximately more that 10-fold (e.g., more than 10, 15, 20, 25, 30, 35, 40, 45, 50, 55, 60, 65, 70, 75, 80, 85, 90, 95, or 100-fold), approximately more than 50-fold (e.g., more than 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold), approximately more than 100-fold (e.g., more than 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, or 1000-fold), or approximately 50-fold to 500-fold (e.g., 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold); and the frequency of droplet input and/or droplet output are greater than 100 Hz (e.g., greater than 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), greater than 250 Hz (e.g., greater than 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), greater than 500 Hz (e.g., greater than 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), in the range of 100-1000 Hz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz), in the range of 250-1000 Hz (e.g., 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz), or in the range of 500-1000 Hz (e.g., 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz).

In some embodiments, the microfluidic washing device described herein is a component of a microfluidic device or system. Accordingly, in some embodiments, a microfluidic device comprises a microfluidic washing component as described herein and at least one other microfluidic module, component, or device. In some embodiments, a system comprises a microfluidic device described herein and at least one other microfluidic module, component, or device. Microfluidic devices and modules, e.g., for producing a biochemical or chemical product, and associated valves, pumps, connections, channels, methods of fabrication, etc., are described in International Patent Application No. PCT/US2017/029062 and U.S. Pat. No. 6,536,477, U.S. Pat. App. Pub. No. 2017/0038368, each of which is incorporated herein by reference.

In some embodiments, the microfluidic device comprises multiple washing buffers (e.g., 2 or more (e.g., 2, 3, 4, 5, 6, 7, 8, 9, 10, or more washing buffers)). In some embodiments, the microfluidic device comprises multiple wash buffer inlets (e.g., 2 or more (e.g., 2, 3, 4, 5, 6, 7, 8, 9, 10, or more wash buffer inlets). In some embodiments, each wash buffer inlet in a multiple washing buffer device provides a wash buffer to the device. In some embodiments, each wash buffer is different. In some embodiments, two or more of the wash buffers is/are the same.

The wash buffers co-flow in parallel and microfluidic laminar flow maintains boundaries between washing buffer streams in co-flow; accordingly, the composition of each buffer stream remains distinct. Therefore, when the microfluidic magnetic bead washing operation attracts beads, each bead passes through the plurality of multiple flowing washing buffer streams. In some embodiments, the multiple buffers vary in composition and/or in concentration. In some embodiments, droplet resegmentation is performed by one or more of the co-flowing washing buffer flows. In some embodiments, diffusional mixing can partly combine two or more of the washing buffers near their co-flowing interface. In some embodiments, the extent of buffer mixing is controlled (e.g., increased or reduced) by the device design. This design may be correspondingly altered to accommodate various magnetic beads.

In some embodiments, flow of washing buffer and/or droplets is driven by, e.g., gravity, vacuum, pressure, or by a pump (e.g., a peristaltic pump, a reciprocating pump, syringe pump, etc.)

### Microfluidic Reactor

In some embodiments, the technology provides a microfluidic device as described herein for initiating, controlling, and/or terminating chemical and/or biochemical reactions. For example, in some embodiments, the microfluidic device described herein provides one or more reactants, inhibitors, catalysts, solvents, or other components of a chemical or biochemical reaction, e.g., in a laminarly flowing stream (e.g., in a laminarly flowing buffer). Accordingly, in some embodiments, the microfluidic technology finds use to deliver chemical and/or biological species to interact with a bead-bound analyte in useful ways. The microfluidic reactor technology finds use in sample processing, sample analysis, and/or (bio)chemical synthesis, etc. During the development of embodiments of the technology provided herein, experiments were conducted to test the use of a microfluidic technology as provided herein as a microfluidic reactor. In particular, experiments were conducted to test the device using enzyme inhibition where the washing buffer both removes an inhibiting chemical (IPTG) and delivers a substrate for the bead-bound enzyme to initiate a biochemical reaction. See, e.g., Example entitled “Enzyme Inhibition Reversal”.

### Washing Methods

Embodiments of the technology relate to methods for washing a bead-bound analyte. In some embodiments, methods comprise providing a microfluidic device as described herein. In some embodiments, methods comprise providing input droplets comprising a magnetic particle to a microfluidic device as described herein (e.g., to a droplet inlet of a microfluidic device as described herein). In some embodiments, methods comprise providing a wash buffer stream (e.g., flowing a wash buffer from a wash buffer inlet to a wash buffer (e.g., waste) outlet). In some embodiments, flowing the wash buffer comprises providing a pressure, a vacuum, or a mechanical pump (e.g., a peristaltic pump, a reciprocating pump, a syringe pump, etc.). In some embodiments, gravity drives flow of the wash buffer. In some embodiments, flow of droplets is driven by providing a pressure, a vacuum, or a mechanical pump (e.g., a peristaltic pump, a reciprocating pump, a syringe pump, etc.). In some embodiments, flow of droplets is driven by gravity.

In some embodiments, methods comprise providing multiple wash buffer streams that co-flow in the device without mixing, without substantially mixing, without effectively mixing, and/or without detectably mixing.

In some embodiments, methods comprise coalescing an input droplet comprising a magnetic particle with a wash buffer stream (see, e.g., FIG. 1). In some embodiments, coalescing an input droplet with a wash buffer stream comprises destabilizing the input droplet. In some embodiments, coalescing an input droplet with a wash buffer stream comprises providing an electric potential across the input droplet (e.g., across a stream of input droplets provided at a droplet inlet of the microfluidic device described herein). In some embodiments, coalescing an input droplet comprises providing a chemical agent that coalesces droplets with each other and/or with the wash buffer stream.

In some embodiments, methods comprise attracting a magnetic particle (e.g., from the proximal side to the distal side as flow moves from the inlet side to the outlet side; see FIG. 1). In some embodiments, attracting a magnetic particle comprises providing a magnetic field. In some embodiments, attracting a magnetic particle comprises providing a magnet (e.g., a permanent magnet, an electromagnet). In some embodiments, methods comprise attracting a magnetic particle to the distal side of the microfluidic device by providing a magnet at the distal side of the microfluidic device. In some embodiments, methods comprise attracting a magnetic particle to the distal side of the microfluidic device by providing a magnetic field that moves magnetic particles to the distal side of the microfluidic device. In some embodiments, attracting a magnetic particle comprises providing electricity to an electromagnet. In some embodiments, attracting a magnetic particle moves the magnetic particle into a washing buffer. In some embodiments, attracting a magnetic particle moves the magnetic particle out of a washing buffer. In some embodiments, attracting a magnetic particle moves the magnetic particle across a washing buffer. In some embodiments, attracting a magnetic particle moves the magnetic particle across multiple washing buffers (e.g., 2, 3, 4, 5, 6, 7, 8, 9, or 10 or more washing buffers). In some embodiments, attracting a magnetic particle moves the magnetic particle across multiple different washing buffers (e.g., 2, 3, 4, 5, 6, 7, 8, 9, or 10 or more different washing buffers). In some embodiments, two or more of the multiple washing buffers are the same.

In some embodiments, methods comprise reforming output droplets comprising magnetic particles (see, e.g., FIG. 1). In some embodiments, methods comprise reforming output droplets at a droplet outlet of the microfluidic device.

In some embodiments, methods comprise removing wash buffer at a wash buffer outlet.

In some embodiments, methods comprise processing droplets at a frequency of droplet input and/or droplet output that are greater than 100 Hz (e.g., greater than 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, methods comprise processing droplets at a frequency of droplet input and/or droplet output that are greater than 250 Hz (e.g., greater than 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, methods comprise processing droplets at a frequency of droplet input and/or droplet output that are greater than 500 Hz (e.g., greater than 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more). In some embodiments, methods comprise processing droplets at a frequency of droplet input and/or droplet output that are in the range of 100-1000 Hz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz). In some embodiments, methods comprise processing droplets at a frequency of droplet input and/or droplet output that are in the range of 250-1000 Hz (e.g., 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz). In some embodiments, methods comprise processing droplets at a frequency of droplet input and/or droplet output that are in the range of 500-1000 Hz (e.g., 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz).

In some embodiments, methods comprise processing droplets at a frequency of droplet input and/or droplet output that is 0.1-10 Hz. (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 Hz) or 10-100 Hz (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 Hz).

In some embodiments, methods comprise processing droplets at input and output frequencies that are the same or essentially the same. In some embodiments, the input and output frequencies are within 5-10% (e.g., 5.0, 5.5, 6.0, 6.5, 7.0, 7.5, 8.0, 8.5, 9.0, 9.5, 10.0) of one another. In some embodiments, methods comprise processing droplets at input and output frequencies that are different or essentially different. In some embodiments, the input and output frequencies are different by more than 1-10% (e.g., 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0%).

In some embodiments, methods provide greater than 95% bead recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%). In some embodiments, methods provide greater than 95% analyte recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%).

In some embodiments, methods produce output droplets that are diluted relative to input droplets approximately more that 10-fold (e.g., more than 10, 15, 20, 25, 30, 35, 40, 45, 50, 55, 60, 65, 70, 75, 80, 85, 90, 95, or 100-fold). In some embodiments, methods produce output droplets that are diluted relative to input droplets approximately more than 50-fold (e.g., more than 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold). In some embodiments, methods produce output droplets that are diluted relative to input droplets approximately more than 100-fold (e.g., more than 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, or 1000-fold). In some embodiments, methods produce output droplets that are diluted relative to input droplets approximately 50-fold to 500-fold (e.g., 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold).

In some embodiments, methods provide greater than 95% bead and/or analyte recovery in output droplets relative to input droplets (e.g., greater than 95.0, 95.1, 95.2, 95.3, 95.4, 95.5, 95.6, 95.7, 95.8, 95.9, 96.0, 96.1, 96.2, 96.3, 96.4, 96.5, 96.6, 96.7, 96.8, 96.9, 97.0, 97.1, 97.2, 97.3, 97.4, 97.5, 97.6, 97.7, 97.8, 97.9, 98.0, 98.1, 98.2, 98.3, 98.4, 98.5, 98.6, 98.7, 98.8, 98.9, 99.0, 99.1, 99.2, 99.3, 99.4, 99.5, 99.6, 99.7, 99.8, 99.9, 99.95, or 99.99%); and the output droplets are diluted relative to input droplets approximately more that 10-fold (e.g., more than 10, 15, 20, 25, 30, 35, 40, 45, 50, 55, 60, 65, 70, 75, 80, 85, 90, 95, or 100-fold), approximately more than 50-fold (e.g., more than 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold), approximately more than 100-fold (e.g., more than 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, or 1000-fold), or approximately 50-fold to 500-fold (e.g., 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500-fold); and the frequency of droplet input and/or droplet output are greater than 100 Hz (e.g., greater than 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), greater than 250 Hz (e.g., greater than 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), greater than 500 Hz (e.g., greater than 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz or more), in the range of 100-1000 Hz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz), in the range of 250-1000 Hz (e.g., 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz), or in the range of 500-1000 Hz (e.g., 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 Hz).

### Systems

In some embodiments, the technology provides systems. In some embodiments, systems comprise a microfluidic device as described herein. In some embodiments, systems comprise a microfluidic device as described herein in fluid communication with a second microfluidic device connected by the droplet inlet. In some embodiments, systems comprise a microfluidic device as described herein in fluid communication with a second microfluidic device connected by the droplet outlet. In some embodiments, systems comprise a plurality of microfluidic devices as described herein operating in parallel. In some embodiments, systems comprise a plurality of microfluidic devices as described herein operating in series.

In some embodiments, systems comprise a detection means configured to detect a signal produced by an analyte, a magnetic bead, a droplet, or a component of the wash buffer (e.g., at any position or time in the microfluidic device (e.g., prior to washing the droplets, during washing, or after washing).

In some embodiments, systems comprise a microprocessor configured to control flow of droplets into the microfluidic device (e.g., at the droplet inlet), to control flow of droplets out of the microfluidic device (e.g., at the droplet outlet), to control flow of wash buffer from the wash buffer inlet to the wash buffer outlet, to produce a magnetic field (e.g., at the distal side of a microfluidic device), and/or to produce an electric potential. In some embodiments, a microprocessor controls a detector configured to detect a signal produced by an analyte, a magnetic bead, a droplet, or a component of the wash buffer (e.g., at any position or time in the microfluidic device (e.g., prior to washing the droplets, during washing, or after washing).

In some embodiments, systems comprise a component to record data. In some embodiments, systems comprise a component to display data. In some embodiments, systems comprise a component to transmit data.

In some embodiments, systems comprise a component to control flow of droplets into the microfluidic device (e.g., at the droplet inlet), to control flow of droplets out of the microfluidic device (e.g., at the droplet outlet), to control flow of wash buffer from the wash buffer inlet to the wash buffer outlet, to produce a magnetic field (e.g., at the distal side of a microfluidic device), and/or to produce an electric potential based on a signal detected by a detection means and/or the quantitative value of a signal detected by a detection means.

In some embodiments, systems comprise a component to control flow of a co-flow fluid (e.g., oil) in a microfluidic device. In some embodiments, systems comprise a co-flow fluid (e.g., oil) to resegment droplets at the outlet side. In some embodiments, systems comprise additional co-flow fluid (e.g., oil) flows for resegmenting droplets at the outlet side.

In some embodiments, systems comprise a component to control flow of droplets and/or wash buffer in a microfluidic device. In some embodiments, a component to control flow of droplets and/or wash buffer comprises a component for gravity-driven, vacuum-driven flow, pressure-driven, or mechanical-driven (e.g., pump-driven) flow of fluid (e.g., by a peristaltic pump, a reciprocating pump, a syringe pump, etc.).

### Analytes

The term “analyte” as used herein is a broad term and is used in its ordinary sense, including, without limitation, to refer to a substance or chemical constituent in a sample such as a biological fluid (for example, blood, interstitial fluid, cerebral spinal fluid, lymph fluid or urine) that can be analyzed. Analytes can include naturally occurring substances, artificial substances, metabolites, and/or reaction products. In some embodiments, the analyte comprises a salt, sugars, protein, fat, vitamin, or hormone. In some embodiments, the analyte is naturally present in a biological sample (e.g., is “endogenous”); for example, in some embodiments, the analyte is a metabolic product, a hormone, an antigen, an antibody, and the like. Alternatively, in some embodiments, the analyte is introduced into a biological organism (e.g., is “exogenous), for example, a drug, drug metabolite, a drug precursor (e.g., prodrug), a contrast agent for imaging, a radioisotope, a chemical agent, etc. The metabolic products of drugs and pharmaceutical compositions are also contemplated analytes.

In some embodiments, the analyte is a polypeptide, a nucleic acid, a small molecule, a lipid, a carbohydrate, a polysaccharide, a fatty acid, a phospholipid, a glycolipid, a sphingolipid, an organic molecule, an inorganic molecule, cofactor, pharmaceutical, bioactive agent, a cell, a tissue, an organism, etc. In some embodiments, the analyte comprises a polypeptide, a nucleic acid, a small molecule, a lipid, a carbohydrate, a polysaccharide, a fatty acid, a phospholipid, a glycolipid, a sphingolipid, an organic molecule, an inorganic molecule, cofactor, pharmaceutical, bioactive agent, a cell, a tissue, an organism, etc. In some embodiments, the analyte comprises a combination of one or more of a polypeptide, a nucleic acid, a small molecule, a lipid, a carbohydrate, a polysaccharide, a fatty acid, a phospholipid, a glycolipid, a sphingolipid, an organic molecule, an inorganic molecule, cofactor, pharmaceutical, bioactive agent, a cell, a tissue, an organism, etc.

In some embodiments, the analyte is part of a multimolecular complex, e.g., a multiprotein complex, a nucleic acid/protein complex, a molecular machine, an organelle (e.g., a cell-free mitochondrion, e.g., in plasma; a plastid; golgi, endoplasmic reticulum, vacuole, peroxisome, lysosome, and/or nucleus), cell, virus particle, tissue, organism, or any macromolecular complex or structure or other entity that can be captured and is amenable to analysis by the technology described herein (e.g., a ribosome, spliceosome, vault, proteasome, DNA polymerase III holoenzyme, RNA polymerase II holoenzyme, symmetric viral capsids, GroEL/GroES; membrane protein complexes: photosystem I, ATP synthase, nucleosome, centriole and microtubule-organizing center (MTOC, cytoskeleton, flagellum, nucleolus, stress granule, germ cell granule, or neuronal transport granule). For example, in some embodiments a multimolecular complex is isolated and the technology finds use in characterizing, identifying, quantifying, and/or detecting one or more molecules (analytes) associated with (e.g., that is a component of) the multimolecular complex. In some embodiments an extracellular vesicle is isolated and the technology finds use in characterizing, identifying, quantifying, and/or detecting one or more molecules (analytes) associated with the vesicle. In some embodiments, the technology finds use in characterizing, identifying, quantifying, and/or detecting a protein (e.g., a surface protein) and/or an analytes present inside the vesicle, e.g., a protein, nucleic acid, or other analyte described herein. In some embodiments, the vesicle is fixed and permeabilized prior to analysis.

As used herein “detect an analyte” or “detect a substance” will be understood to encompass direct detection of the analyte itself or indirect detection of the analyte by detecting its by-product(s).

As used herein for embodiments comprising capture of an analyte by a magnetic bead comprising a binding moiety, the “analyte” is specifically bound by the binding moiety and a “non-analyte” is any substance that is not the bound analyte or not targeted for binding by the binding moiety (e.g., a contaminant). A “non-analyte” includes substances and compositions as described above that might be considered “analytes” when the binding moiety is specific for such substances and compositions, but that are considered to be “non-analytes” when the binding moiety is not specific for such substances and compositions.

### Samples and Sample Handling

The technology relates to the processing of samples, e.g., biological samples, associated with a bead (e.g., specifically bound to a binding moiety of a bead). Examples of samples include various fluid samples. In some instances, the sample is a bodily fluid sample from a subject. In some embodiments, the sample is an aqueous or a gaseous sample. In some embodiments, the sample includes one or more fluid component. In some embodiments, solid or semi-solid samples are provided. In some embodiments, the sample comprises tissue collected from a subject. In some embodiments, the sample comprises a bodily fluid, secretion, and/or tissue of a subject. In some embodiments, the sample is a biological sample. In some embodiments, the biological sample is a bodily fluid, a secretion, and/or a tissue sample. Examples of biological samples include but are not limited to, blood, serum, saliva, urine, gastric and digestive fluid, tears, stool, semen, vaginal fluid, interstitial fluids derived from tumorous tissue, ocular fluids, sweat, mucus, earwax, oil, glandular secretions, breath, spinal fluid, hair, fingernails, skin cells, plasma, nasal swab or nasopharyngeal wash, spinal fluid, cerebral spinal fluid, tissue, throat swab, biopsy, placental fluid, amniotic fluid, cord blood, emphatic fluids, cavity fluids, sputum, pus, micropiota, meconium, breast milk, and/or other excretions. In some embodiments, the sample is provided from a human or an animal, e.g., in some embodiments the sample is provided from a mammal (e.g., a vertebrate) such as a murine, simian, human, farm animal, sport animal, or pet. In some embodiments, the sample is collected from a living subject and in some embodiments the sample is collected from a dead subject.

In some embodiments, the sample is collected fresh from a subject and in some embodiments the sample has undergone some form of pre-processing, storage, or transport, e.g., by a microfluidic device upstream of a microfluidic washing device described herein and that provides input droplets at the droplet inlet of a device as described herein.

In some embodiments, the sample is provided to a microfluidic device from a subject without undergoing intervention or much elapsed time. In some embodiments, the subject contacts the microfluidic device to provide the sample. In some embodiments, the sample is provided to the microfluidic device described herein by another microfluidic device that processes a sample prior to delivery to an embodiment of the microfluidic washing device described herein (e.g., to provide input droplets comprising magnetic beads).

In some embodiments, a subject provides a sample and/or the sample may be collected from a subject. In some embodiments, the subject is a patient, clinical subject, or pre-clinical subject. In some embodiments, the subject is undergoing diagnosis, treatment, and/or disease management or lifestyle or preventative care. The subject may or may not be under the care of a health care professional.

In some embodiments, the sample is collected from the subject by puncturing the skin of the subject or without puncturing the skin of the subject. In some embodiments, the sample is collected through an orifice of the subject. In some embodiments, a tissue sample (e.g., an internal or an external tissue sample) is collected from the subject. In some embodiments, the sample is collected from a portion of the subject including, but not limited to, the subject's finger, hand, arm, shoulder, torso, abdomen, leg, foot, neck, ear, or head.

In some embodiments, one type of sample is accepted and/or processed by the microfluidic device. Alternatively, in some embodiments multiple types of samples are accepted and/or processed by the microfluidic device. For example, in some embodiments the microfluidic device is capable of accepting one or more, two or more, three or more, four or more, five or more, six or more, seven or more, eight or more, nine or more, ten or more, twelve or more, fifteen or more, twenty or more, thirty or more, fifty or more, or one hundred or more types of samples. In some embodiments, the microfluidic device is capable of accepting and/or processing any of these numbers of sample types simultaneously and/or at different times from different or the same matrices. For example, in some embodiments the microfluidic device is capable of washing one or multiple types of samples, e.g., the technology provides a plurality of microfluidic washing devices operating in parallel.

The technology is not limited in the volume of sample that is processed by the microfluidic device. Accordingly, embodiments provide that any volume of sample is provided from the subject or from another source. Examples of volumes may include, but are not limited to, approximately 10 mL or less, 5 mL or less, 3 mL or less, 1 mL or less, 500 or less, 300 μL or less, 250 μL or less, 200 μL or less, 170 μL or less, 150 μL or less, 125 or less, 100 μL or less, 75 μL or less, 50 μL or less, 25 μL or less, 20 μL or less, 15 μL or less, 10 μL or less, 5 μL or less, 3 μL or less, 1 μL or less, 500 nL or less, 250 nL or less, 100 nL or less, 50 nL or less, 20 nL or less, 10 nL or less, 5 nL or less, 1 nL or less, 500 pL or less, 100 pL or less, 50 pL or less, or 1 pL or less. The amount of sample may be approximately a drop of a sample. The amount of sample may be approximately 1 to 5 drops of sample, 1 to 3 drops of sample, 1 to 2 drops of sample, or less than a drop of sample. The amount of sample may be the amount collected from a pricked finger or fingerstick. Any volume, including those described herein, is provided to the device in various embodiments.

Further, in some embodiments a sample collection unit and/or sample reaction chamber is integral to the microfluidic device. And, in some embodiments the sample collection unit and/or sample reaction chamber is separate from the microfluidic device. In some embodiments, the sample collection unit and/or sample reaction chamber is removable and/or insertable from the microfluidic device or is removable and/or insertable from an apparatus comprising the microfluidic device. In some embodiments, the sample collection unit and/or sample reaction chamber is provided in the microfluidic device; in some embodiments the sample collection unit and/or sample reaction chamber is not provided in the microfluidic device. In some embodiments, the microfluidic device is removable and/or insertable from an apparatus.

In some embodiments a sample collection unit and/or sample reaction chamber is configured to receive a sample. In some embodiments, the sample collection unit is capable of containing and/or confining the sample. In some embodiments, the sample collection unit is capable of conveying the sample to the microfluidic device.

In some embodiments, a microfluidic device is configured to accept a single sample; in some embodiments a microfluidic device is configured to accept multiple samples. In some embodiments, the multiple samples comprise multiple types of samples. For example, in some embodiments a single microfluidic device handles a single sample at a time. For example, in some embodiments a microfluidic device receives a single sample and performs one or more sample processing steps, such as a lysis steps, isolation steps, reaction steps, and/or a separation steps with the sample. In some embodiments, the microfluidic device completes processing a sample before accepting a new sample.

In other embodiments, a microfluidic device is capable of handling multiple samples simultaneously. In one example, a microfluidic device receives multiple samples simultaneously. In some embodiments, the multiple samples comprise multiple types of samples. Alternatively, in some embodiments the microfluidic device receives samples in sequence. Samples are provided in some embodiments to the microfluidic device one after another or, in some embodiments, samples are provided to the microfluidic device after any amount of time has passed. A microfluidic device in some embodiments begins sample processing on a first sample, receives a second sample during said sample processing, and processes the second sample in parallel with the first sample. In some embodiments, the first and second samples are not the same type of sample. In some embodiments, the microfluidic device processes any number of samples in parallel, including but not limited to more than and/or equal to approximately one sample, two samples, three samples, four samples, five samples, six samples, seven samples, eight samples, nine samples, ten samples, eleven samples, twelve samples, thirteen samples, fourteen samples, fifteen samples, sixteen samples, seventeen samples, eighteen samples, nineteen samples, twenty samples, twenty-five samples, thirty samples, forty samples, fifty samples, seventy samples, one hundred samples.

In some embodiments, the microfluidic device processes one, two, or more samples in parallel. The number of samples that are processed in parallel may be determined by the number of available modules, reaction chambers, and/or components in the microfluidic device, e.g., flow channels, components for producing an electric potential, components for producing a magnetic field, droplet inlets, droplet outlets, wash buffer inlets, and/or wash buffer outlets.

When a plurality of samples is processed simultaneously, embodiments provide that the samples begin and/or end processing at any time. For example, the samples need not begin and/or end processing at the same time. In some embodiments, a first sample has completed processing while a second sample is still being processed. In some embodiments, the second sample has begun processing after the first sample has begun processing. As samples have completed processing, additional samples are added to the device in some embodiments. In some embodiments, the microfluidic device runs continuously with samples being added to the device as various samples have completed processing.

In some embodiments, multiple samples are provided simultaneously. In some embodiments, multiple samples are not the same type of sample. In some embodiments, multiple sample collection units are provided to a microfluidic device. In some embodiments, the multiple sample collection units receive samples simultaneously and in some embodiments the multiple sample collection units receive samples at different times. In some embodiments, multiples of any of the sample collection mechanisms described herein are used in combination.

In some embodiments, multiple samples are provided in sequence. In some embodiments, multiple sample collection units are used and in some embodiments single sample collection units are used. Embodiments provide any combination of sample collection mechanisms described herein. In some embodiments, a microfluidic device accepts one sample at a time, two samples at a time, or more. In some embodiments, samples are provided to the microfluidic device after any amount of time has elapsed.

### Computer and Software

In some embodiments, the technology described herein is associated with a programmable machine designed to perform a sequence of arithmetic, logical, or control operations, e.g., as provided by the methods described herein, either contiguous to the microfluidic device, proximate, or utilized in concert. For example, some embodiments of the technology are associated with (e.g., implemented in) computer software and/or computer hardware. In one aspect, the technology relates to a computer comprising a form of memory, an element for performing arithmetic, logical, and/or control operations, and a processing element (e.g., a processor or a microprocessor) for executing a series of instructions (e.g., a method as provided herein) to read, manipulate, and store data. Some embodiments comprise one or more processors. In some embodiments, a processor provides instructions to control one or more valves, components, modules, thermoelectric components, piezoelectric components, pumps, reagent supplies, etc. in the microfluidic device and/or apparatus. In some embodiments, a processor provides instructions to control a component that generates an electric field (e.g., potential). In some embodiments, a processor provides instructions to control a component that generates a magnetic field.

In some embodiments, a microprocessor is part of a system comprising one or more of a CPU, a graphics card, a user interface (e.g., comprising an output device such as a display and an input device such as a keyboard), a storage medium, and memory components. Memory components (e.g., volatile and/or nonvolatile memory) find use in storing instructions (e.g., an embodiment of a process as provided herein) and/or data. Programmable machines associated with the technology comprise conventional extant technologies and technologies in development or yet to be developed (e.g., a quantum computer, a chemical computer, a DNA computer, an optical computer, a spintronics based computer, etc.).

Some embodiments provide a computer that includes a computer-readable medium. The embodiment includes a random access memory (RAM) coupled to a processor. The processor executes computer-executable program instructions stored in memory. Such processors may include a microprocessor, an ASIC, a state machine, or other processor, and can be any of a number of computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein.

Embodiments of computer-readable media include, but are not limited to, an electronic, optical, magnetic, or other storage or transmission device capable of providing a processor, such as the processor of client, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, Swift, Ruby, Unix, and JavaScript. In some embodiments, instructions are provided by National Instruments LabView.

Computers are connected in some embodiments to a network or, in some embodiments, can be stand-alone machines. Computers may also include a number of external or internal devices such as a mouse, a CD-ROM, DVD, a keyboard, a display, or other input or output devices. Examples of computers are personal computers, digital assistants, personal digital assistants, cellular phones, mobile phones, smart phones, pagers, digital tablets, laptop computers, internet appliances, and other processor-based devices. In general, the computer-related to aspects of the technology provided herein may be any type of processor-based platform that operates on any operating system, such as Microsoft Windows, Linux, UNIX, macOS, etc., capable of supporting one or more programs comprising the technology provided herein. All such components, computers, and systems described herein as associated with the technology may be logical or virtual.

### Data Collection and Analysis

In some embodiments, assay data are produced, e.g., comprising or calculated from signals detected, evaluated, and/or recorded by a detection means. Following the production of assay data, the assay data are reported to a data analysis operation in some embodiments. Data may be stored on the device, telemetered to a proximate data storage means or at a distance via bluetooth or other contained transmission means or via connectivity to the world-wide web. To facilitate data analysis in some embodiments, the assay data are analyzed by a digital computer. In some embodiments, the computer is appropriately programmed for receipt and storage of the assay data and for analysis and reporting of the assay data gathered, e.g., to provide data in a human or machine readable format.

In some embodiments, a computer-based analysis program is used to translate the data generated by an assay into data of predictive value for a clinician. The clinician can access the predictive data using any suitable means. Thus, in some preferred embodiments, the present invention provides the further benefit that the clinician, who is not likely to be trained in genetics or molecular biology, need not understand the raw data. The data is presented directly to the clinician in its most useful form. The clinician is then able to utilize the information immediately to optimize the care of the subject. The present invention contemplates any method capable of receiving, processing, and transmitting the information to and from laboratories conducting the assays, information providers, medical personal, and subjects.

### EXAMPLES

During the development of embodiments of the technology described herein, experiments were conducted to develop a technology for solid phase sample capture and washing for continuously flowing droplet microfluidics. Embodiments of the technology provide efficient, high throughput magnetic washing by electrocoalescing magnetic bead-laden input droplets with a washing buffer flow and magnetophoretically transporting beads through the buffer into a secondary droplet formation streamline. Experiments were conducted to test the throughput, sample retention, and flow-based exclusion of waste volume provided by embodiments of the technology. Data collected during the experiments indicated that the technology processes droplets at approximately 500 Hz and provided greater than 98% bead retention and greater than 100-fold dilution in output droplets. During the development of embodiments of the technology, experiments were conducted to test embodiments of the technology for processing droplets comprising alternative commercially available magnetic beads (e.g., beads comprising lower magnetite content per particle). In addition, experiments were conducted during the development of embodiments of the technology to test sample washing. First, experiments were conducted using embodiments of the technology to wash away a small molecule competitive inhibitor from magnetic bead-immobilized 6-galactosidase to restore the enzymatic activity of the galactosidase. Second, experiments were conducted using embodiments of the technology to enrich immunomagnetically a Green Fluorescent Protein-Histone H2B fusion from cell lysate while washing away mCherry and other lysate components. The experiments indicate that the technology provides improved biochemical and bioanalytical techniques for droplet microfluidic technologies and finds use in applications such as, e.g., droplet-based immunoassays and solid phase extraction.

### Experimental Methods

Microfluidic Device Preparation. Devices were fabricated using standard soft lithography (33). In brief, SU8 2025 Negative Epoxy Photoresist (MicroChem Corp.) was spin coated to 40-μm thickness on silicon wafers (University Wafer). Devices were designed in AutoCAD software (Autodesk, Inc.) and sourced as transparencies (CAD/Art Services, Inc.) for use in photolithography. Developed wafers were surface treated under vacuum with tridecafluoro-1,1,2,2-tertrahydrooctyl trichlorosilane (Gelest, Inc.) prior to use. 5:1 base:curing agent ratio PDMS (RTV615, Momentive Performance Materials, Inc.) devices were bonded to glass cover slips (Sigma Aldrich) via oxygen plasma activation (PDC-32G, Harrick Plasma, Inc.) after preparing inlet ports. All devices were treated with 1% tridecafluoro-1,1,2,2-tertrahydrooctyl trichlorosilane in Fluoroinert FC-40 (Sigma Aldrich) prior to use.

Flow Control.

Flow control on-device used a custom pressure controller. Nitrogen gas was directed through a splitting manifold to a two-stage regulator array (VWR International) which selected applied pressures. From the regulators, gas was directed into a network of LHDA0531115H solenoid valves (The Lee Company) actuated by LabView via a NI PCIe-6251 Multifunction Data Acquisition Device (National Instruments Corporation) and the gas was delivered through stainless steel pins (New England Small Tube Corporation) into the headspace of solution-filled reservoir vials connected to microfluidic device inlets through lengths of #30 PTFE tubing (Cole-Parmer). Applied pressures were between 10 and 100 kPa.

Electric and Magnetic Fields.

An electric field was generated using a custom inverter to apply a potential of approximately 45 VAC to the device. The electric field was connected via a submerged platinum wire in the washing buffer reservoir and via a syringe with 3-M NaCl used to fill saline electrode channels (34). A magnetic field was provided by an array of eight grade N52 NdFeB ½ inch×¼ inch×⅛ inch magnets (K&J Magnetics, Inc.) positioned 200-500 μm from the channel using microfabricated alignment marks.

Reagents and Sample Preparation.

Magnetic beads were Streptavidin Microparticles, 10-μm particle size (e.g., comprising greater than or equal to 20% magnetite) (Sigma Aldrich), or Protein G Dynabeads, 2.8-μm particle size (e.g., comprising approximately 14% magnetite) (Thermo Fisher Scientific). Beads were rinsed in water or buffer and re-suspended prior to use. For device characterization experiments, magnetic beads were re-suspended in 1-mM fluorescein (Sigma Aldrich) in water with 60% Optiprep (Sigma Aldrich) and 20% PBS, and the washing buffer was PBS. The fluorescent standard for these experiments was 10-μM fluorescein in PBS, and the continuous phase oil was 1% or 2% 008-Fluorosurfactant (Ran Biotechnologies, Inc.) in Novec 7500 (The 3M Company).

For the enzyme inhibition assay, 10 μg of 6-galactosidase-biotin labeled from Escherichia coli (Sigma Aldrich) was incubated on 10-μm streptavidin microparticles for 2 hours, then washed to remove unbound enzyme and re-suspended in 60% optiprep with 40% PBS and 0.2% BSA. Substrate (used as washing buffer) was 500 nM resorufin-6-D-galactopyranoside (Thermo Fisher Scientific) prepared in PBS, 0.5% BSA. Initial droplets or substrate with inhibitor also contained 1-mM isopropyl 6-D-1-thiogalactopyranoside (IPTG) (Thermo Fisher Scientific) as indicated.

For the fluorescent protein enrichment assay, the cells were HeLa with Green Fluorescent Protein (GFP)-Histone H2B (H2B) fusion expressed (provided by Mayo Clinic). Briefly, the cell sample processing procedure included bulk lysis and enzymatic chromatin digestion of approximately 250,000 cells in detergent-rich Lysis and Digestion Buffers with Micrococcal Nuclease (New England BioLabs) as described previously (7). mCherry (BioVision, Inc.) was added to 3.3 μg/mL for the final cell lysate suspension. Anti-GFP beads were prepared using 10-μm streptavidin microparticles with 4.5 μg of rabbit anti-jellyfish GFP polyclonal antibody (Thermo Fisher Scientific) following biotinylation of the antibody (EZ-Link Sulfo-NHS-LC-Biotin, Thermo Fisher Scientific). After overnight incubation in 10 mM HEPES, 150 mM NaCl, 50 mM EDTA, 0.1% PEG, pH 7.4, beads were manually washed and re-suspended in a fresh aliquot of the same buffer to remove unbound antibodies. This buffer was also used as the washing buffer during microfluidic operation.

Data Collection and Analysis.

Images were collected using a VEO 640L high speed camera (Vision Research Inc.) connected to a DMi8 light microscope (Leica Microsystems). Fluorescent imaging was performed using a FITC filter cube for the green channel and a TXR filter cube for the red channel (Leica Microsystems). Image processing and analysis were performed using ImageJ software (NIH). Representative fluorescent images in figures were uniformly adjusted in brightness by fluorescent channel for ease of visualization, but quantitative data were obtained from the original images. For device characterization, droplet fluorescence localization plots average N=20 time-points each, and the final plots were smoothed using a five-point moving average. Plots of intensity values for the enzyme inhibition and fluorescent protein enrichment assays provide representative results for at least N=50 droplets or beads for each reported sub-population. Statistical significance was assessed using a two-sample Student's t-Test with a 95% confidence significance threshold (significance indicated by an asterisk in plots).

### Sample Purification and Washing

During the development of embodiments of the technology, experiments were conducted to design, test, and provide a robust and effective droplet-based magnetic purification and washing method (see, e.g., FIG. 1). As shown in FIG. 1, embodiments of the microfluidic device technology accept droplets comprising a magnetic bead solid phase (e.g., comprising superparamagnetic beads). After droplets enter the microfluidic device, the droplets are subjected to a destabilizing electric field. This electric field causes droplets to coalescence with a parallel washing buffer stream. In some embodiments, the electric field is generated on-device by directly charging a suitably conductive washing buffer and/or through conventional electrolyte-filled microchannel features (34). The device further comprises a magnet adjacent to the flow channel and as the boundaries between each input droplet and the washing buffer fuse, the magnetic beads escape the original droplet volume under the attractive influence of the magnet. While laminar flow of the input droplet fluid in the microfluidic device confines the input droplet fluid to its original streamline with relatively little mixing into the buffer flow, the magnetic beads fully translate across the channel width into the wash stream. In some embodiments, an oil co-flow provides a moving boundary to stop beads from reaching the channel wall and thus keep them moving towards the end of the module. In the absence of this co-flow, in some embodiments beads may be trapped under the combined influence of maximum magnetic field and minimum orthogonal flow forces in the near-zero slip flow at the channel wall. As shown in FIG. 1, the majority of channel flow diverts to waste (containing the input droplet volume and much of the washing buffer) and the streamline comprising the washed magnetic beads segments into new droplets in combination with the oil co-flow. The abrupt local decrease in channel cross section and dispersed phase flow rate drives stable droplet formation in a dripping regime (under typical flow conditions) (25). Bead-containing droplets are reformed (now comprising washing buffer) for output by the microfluidic device. The output droplets are suitable for further downstream processing, e.g., microfluidic operations or sequential buffer exchange.

### Performance Characterization.

During the development of embodiments of the technology, the microfluidic device described above (see, e.g., FIG. 1) was used to process droplets comprising 10-μm diameter beads having a high magnetite content (e.g., approximately greater than or equal to 20% magnetite content). Use of these magnetic beads during the experiments provided improved visualization and increased effectiveness for evaluating use of the magnetic field for translating beads across the channel as described above.

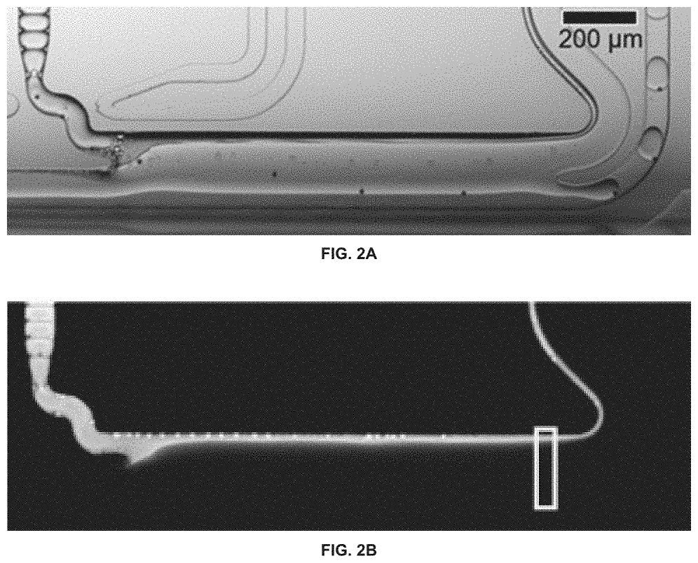

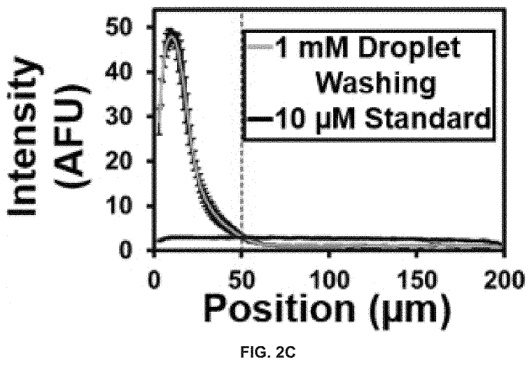

The operation of an embodiment of the technology is shown in FIG. 2A. As droplets comprising beads enter the module (e.g., at 550 Hz and 141±1 pL droplet volume), an electric field is applied across the washing buffer and an adjacent saline electrode channel triggered coalescence. In some embodiments, the device also also includes a second electrode feature nearby to provide washing into lower conductivity buffers. In some embodiments, the technology directly charges the washing buffer. Data collected during the development of embodiments of the technology indicated that directly charging the washing buffer oriented the electric field for maximal and/or most efficient coalescence of input droplets.

Data collected during the experiments indicated that electrocoalescence and local turbulence generated and trapped small satellite volumes, particularly at high droplet processing frequency, but these micron-sized satellite droplet fragments very rarely comprised magnetic beads, especially when using 10-μm particles. In addition, the satellite droplets usually flowed out through the waste channel with no detectable effect on performance or bead recovery.

After droplet coalescence, beads magnetophoretically traversed the channel width until reaching the washing buffer-oil co-flow interface, and beads were effectively re-encapsulated in washing buffer droplets (e.g., at 560 Hz and 189±2 pL droplet volume). Data were collected by monitoring more than 4,000 beads at input and output droplet frequencies of approximately 500 Hz. These data indicated greater than 98% successful bead capture in the output droplets (e.g., calculated by beads output as a fraction of beads input). Further, embodiments provide that adjusting the relative flow rates of the input droplets, washing buffer, oil co-flow, and/or waste outlet stream provides for independently selecting droplet frequencies and/or final droplet size. It is contemplated that this control provides a technology for isolating beads originating from non-identical sample droplets, e.g., because relatively faster output frequencies produced more empty droplets and reduced the incidence of bead co-encapsulation.

Next, experiments were conducted to evaluate the washing efficiency provided by embodiments of the device. Specifically, data were collected to confirm the effective exclusion of free material from the original droplets in the final bead-containing droplets. In these experiments, 1-mM fluorescein was added to starting droplets to provide for the fluorescent monitoring of original droplet contents throughout the module (FIG. 2B). Uniformly flowing a 10-μM fluorescein standard through the device at comparable flow rates provided a reference representing fluorescence intensity at 100-fold dilution relative to the droplets comprising 1 mM fluorescein. The fluorescence of the channel cross-section was monitored and the fluorescent channel cross section data were time-averaged and plotted during operation of the microfluidic device and when collecting the fluorescent reference (FIG. 2C). The data indicated that the fluorescence intensity of the channel became statistically indistinguishable from the reference even before the position in the device flow where the channel bifurcated to divert a fraction of the flow into droplet reformation (FIG. 2C, compare the 50-μm position and the 120-μm position for channel bifurcation). The data further indicated that positions closer to the location of channel bifurcation showed significantly lower fluorescence intensity compared to the reference, indicating effective dilution greater than 100-fold in the output droplets. Although flow rate and geometry adjustments altered the exact channel position corresponding to the 100-fold dilution threshold, these data indicated that the technology provides highly efficient removal of free species from the input droplets.

### Bead Input Versatility

During the development of embodiments of the technology, an embodiment of the microfluidic device was produced that accommodates alternative magnetic particles. In particular, embodiments of device were produced to interface with a broad range of microfluidic modules that produce a variety of droplets comprising magnetic particles for processing by the present device because bead characteristics can vary by assay, e.g., depending on bead properties (e.g., bead coating, bead size, and/or bead binding capacity). Experiments were conducted using commercially available beads comprising a low magnetic content per bead, e.g., to provide a limiting test case for evaluating the device.

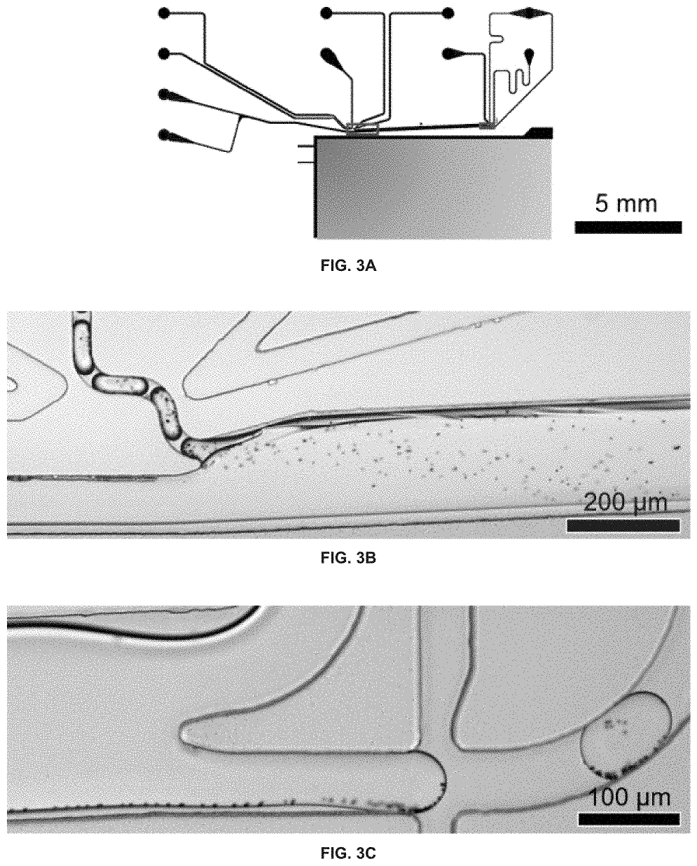

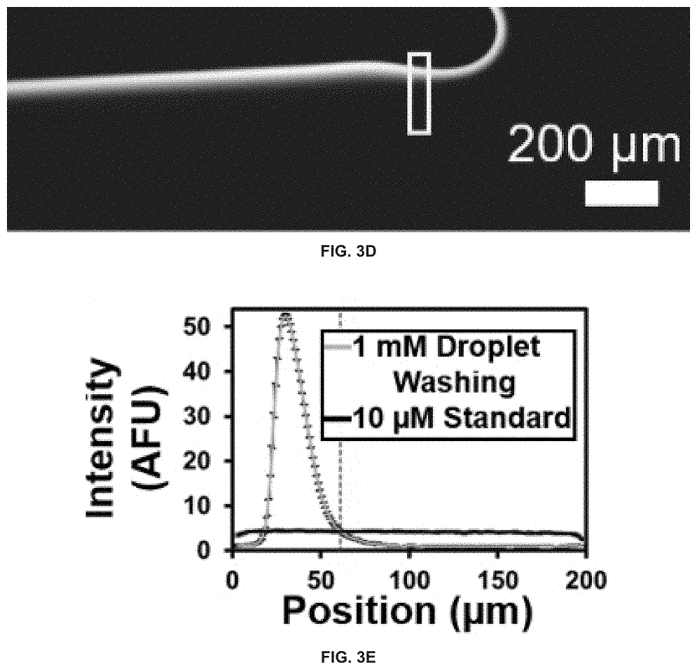

FIG. 3A provides the schematic of the modified microfluidic module for handling 2.8-μm Dynabeads (e.g., comprising approximately 14% magnetite content). In some embodiments, the microfluidic module was modified by extending the magnetophoresis region by more than five-fold compared to the original device. Increased residence time for Dynabeads passing through the extended channel (at relatively fixed flow rates) maximized capture of magnetic beads that were only partially deflected in the initial region of the module as shown in FIG. 3B. FIG. 3C shows deflected particles re-encapsulated in new droplets at the end of the magnetophoresis region. Flow focusing oil channels were added to stabilize this terminal operation. During these experiments, data collected by monitoring more than 1000 Dynabeads at droplet input and output frequencies of at least 200 Hz indicated that bead recovery was greater than 99%. Data were collected using the fluorescent droplet characterization method described above. The data collected for this modified device indicated that the 100-fold dilution threshold was reached at the 60-μm channel position (FIG. 3D-E). The channel bifurcation was present at 120 μm as in the original device described above. While the modified device has a slightly increased footprint and operating complexity, these experiments indicated that performance of the modified device with smaller, lower magnetic content particles was similar to the performance of the original device with the particles having higher magnetic content. Accordingly, these data indicate that embodiments of the technology have broad application and general usability and that the general principles of the technology provide for a broad range of embodiments of the device for processing many types of samples and droplets comprising magnetic beads.

### Enzyme Inhibition Reversal

During the development of embodiments of the technology provided herein, experiments were conducted to test the device for use in biochemical assays. In particular, data were collected in experiments to test the removal of an enzyme inhibitor from a bead-tethered enzyme using the device. In these experiments, biotinylated ß-galactosidase enzyme was tethered to the surface of 10-μm streptavidin magnetic beads. Resorufin-ß-D-galactopyranoside was provided as a substrate for the enzyme and isopropyl ß-D-1-thiogalactopyranoside (IPTG) (a non-hydrolyzable substrate analog for ß-galactosidase) was provided as a competitive inhibitor of the enzyme. The bead-tethered enzyme, substrate, and inhibitor were provided in droplets formed for processing by the device (e.g., washing the inhibitor from the enzyme to recover enzyme activity). Experiments were conducted to test removing the inhibitor from the enzyme using the microfluidic washing device. Data were collected by monitoring the production of fluorescent resorufin by the enzyme as a readout of enzyme activity. Fully recovered enzyme function relative to uninhibited and inhibited controls indicated successful washing to remove the inhibitor.

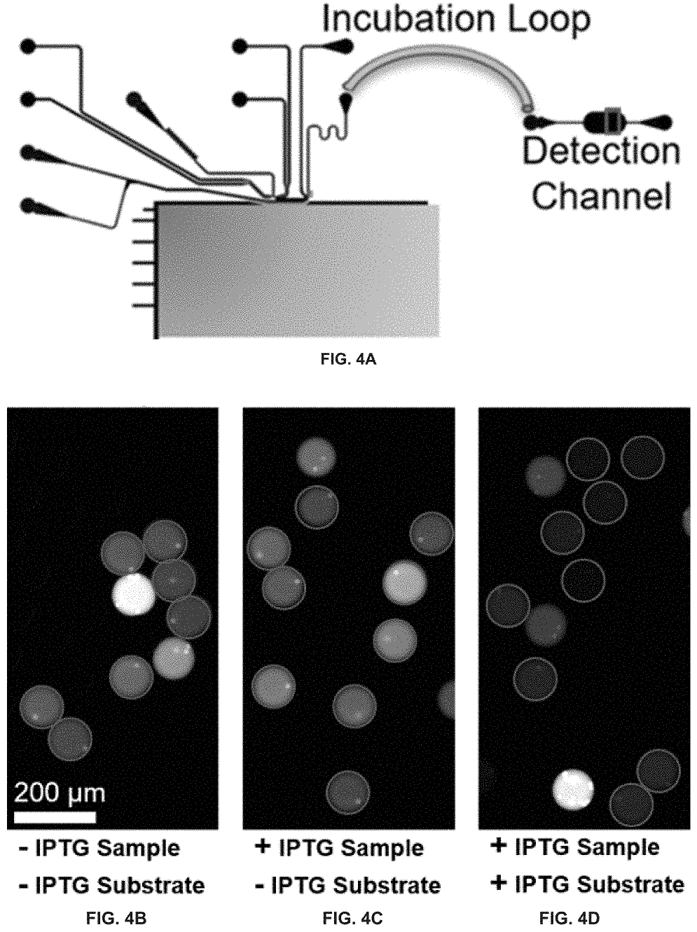

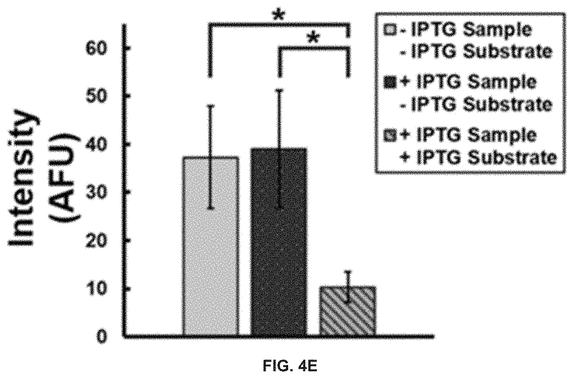

FIG. 4A provides a schematic describing the experiments conducted. Droplets loaded with ß-galactosidase-conjugated beads and IPTG were washed using the microfluidic device with input and output frequencies near 200 Hz and final droplet volumes between 260 and 300 pL. Output droplets flowed through a short loop of connecting tubing to provide an incubation time of approximately 20 seconds while transiting to a secondary device for dynamic imaging within a planar microchannel. To provide an uninhibited control, experiments were conducted without inhibitor. FIG. 4B shows bright fluorescence in collected output droplets during operation without inhibitor provided in the initial droplets or in the final washing buffer. In experiments testing the removal of the inhibitor from the enzyme in input droplets using the microfluidic washing device, output droplets had fluorescence (FIG. 4C) comparable to the output droplets of the uninhibited control (FIG. 4B). A baseline fluorescence value was provided by an inhibited control in which the enzyme was continuously exposed to IPTG in both initial droplets and final washing buffer. FIG. 4D shows the weakly fluorescent droplets of the inhibited enzyme control. To standardize enzyme loading per droplet, quantitative measurements of droplet intensities (FIG. 4E) were performed only for droplets containing a single bead (circled in the images). The inhibited control showed significantly lower fluorescence than the uninhibited control, thus indicating competitive inhibition by IPTG in the inhibited control. In contrast, the fluorescence data indicated that the activity of the enzyme after removing the inhibitor by the microfluidic washing device did not differ significantly from the uninhibited control (e.g., indicating full enzyme activity after washing to remove the inhibitor). Accordingly, the data indicated that the microfluidic washing removed the inhibitor to produce ß-galactosidase enzyme with full activity after washing. These data further indicate the utility of the microfluidic device for efficient removal of small molecules from samples in a biologically relevant context.

### Selective Protein Enrichment

During the development of embodiments of the technology, experiments were conducted to test affinity-based protein enrichment and separation. In these experiments, a HeLa cell line expressing a green fluorescent protein-histone H2B (GFP-H2B) fusion protein in the nucleus was used to provide a target protein that could be fluorescently monitored. In addition, these cells provide an exemplary test case representative of many types of assays because selective enrichment of chromatin-associated targets provides the basis of many important epigenetic bioassays (31). After manual cell lysis and enzymatic chromatin digestion to increase the accessibility of GFP-H2B, mCherry was added to samples to provide an off-target fluorescent protein to remove during washing with other, non-fluorescent lysate components. Anti-GFP antibody-functionalized magnetic particles selectively captured GFP-H2B on beads prior to magnetic washing. Detection of bead-associated fluorescence in green and red channels indicated the presence and/or location of GFP-H2B and mCherry, respectively, at each stage of the enrichment assay.

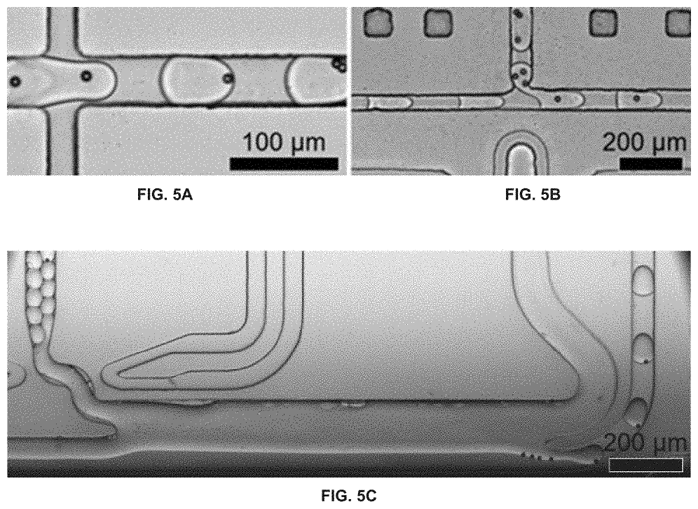

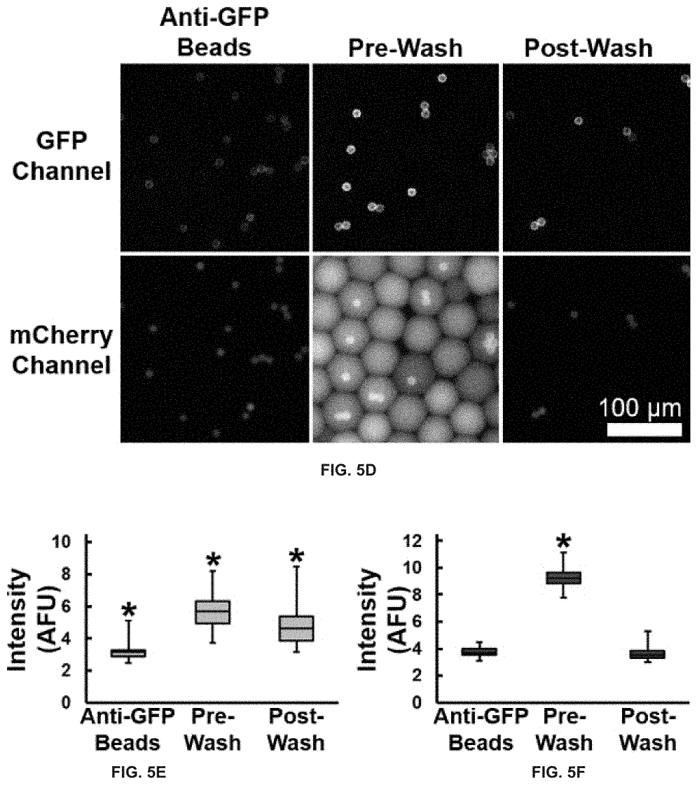

FIG. 5 provides images showing the microfluidic device during the stages of the protein enrichment assay. First, magnetic beads with surface-tethered anti-GFP antibody were rapidly encapsulated in droplets using a flow focusing device at approximately 4 kHz (FIG. 5A), which increased the efficiency of loading droplets with beads by minimizing and/or eliminating gravity-driven settling of dense beads (see, e.g., 35). In particular, emulsifying the entire bead population in the span of a few minutes increased their abundance during processing. Next, the lysate sample was encapsulated in droplets and the bead emulsion was loaded at high packing fraction to provide electrode-mediated direct injection of beads into lysate droplets (FIG. 5B). Bead injection was subject to Poisson statistics and was not completely uniform. Accordingly, in some embodiments, alternative bead loading approaches find use to increase uniformity of bead delivery (e.g., as described in 36). Samples were incubated to allow for binding of GFP-H2B to anti-GFP antibody and then bead-laden droplets were processed via by the microfluidic washing device (FIG. 5C) prior to final imaging. Data collected during the final portion of the assay demonstrated a key advantage of the platform—performance of the device was relatively insensitive to input droplet size and spacing uniformity because the device fuses all droplets with the washing buffer to provide the majority of flow through the module. In particular, the data collected indicated that coalescence was successful without precise coordination or synchronization between droplet and buffer flows (see, e.g., 13). Therefore, the data indicated that, in some embodiments, the microfluidic technology provided herein is capable for interfacing with detergent-enabled bioassays, such as the inclusion of detergent-lysed HeLa droplets. In contrast, other previous washing approaches are compromised by detergent-associated instability and partial channel wetting that cause size or spacing heterogeneities that disrupt the uniformity of droplet synchronization and compromise control of droplet splitting.

Droplets from each portion of the assay were statically imaged in a planar microchannel (FIG. 5D). In both green and red channels, low native fluorescence from antibody-functionalized beads resulted in background signal, but inclusion of GFP-H2B and mCherry when adding cell lysate greatly increased fluorescence intensities before washing, especially the fluorescent signal localized to the beads via specific and non-specific surface interactions. After washing, antibody-antigen interactions retained GFP-H2B on bead surfaces while mCherry was washed away, returning red fluorescence to background levels. In the green fluorescence channel, significantly higher intensities for pre-wash and post-wash beads compared to the original beads indicated successful GFP-H2B enrichment and retention during washing (FIG. 5E). The data indicated that the post-wash beads did have slightly lower fluorescence than pre-wash beads, suggesting a small fraction of sample loss from weak antibody affinity, inconsistent GFP-H2B binding capacity among beads, or the presence of other confounds. Accordingly, in some embodiments, binding conditions for sample capture used for the microfluidic washing technology may be adjusted to maximize sample capture and retention on magnetic particles. As indicated by the data collected in these experiments, red fluorescence from mCherry peaked upon lysate loading prior to washing, but the input beads and output beads after washing did not differ significantly from each other in fluorescence intensity (FIG. 5F). These data indicate that washing as described herein effectively removed non-specifically interacting mCherry, returning signal to background levels. Therefore, the data indicated that the microfluidic washing module described herein succeeded in selectively enriching and separating GFP-H2B from mCherry and HeLa lysate components.

### Microfluidic Device Design

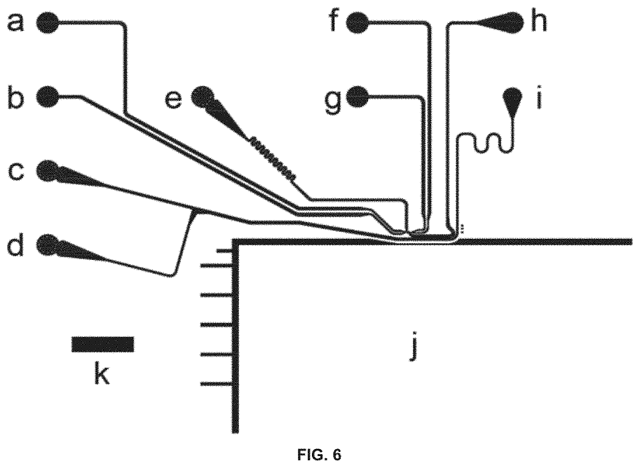

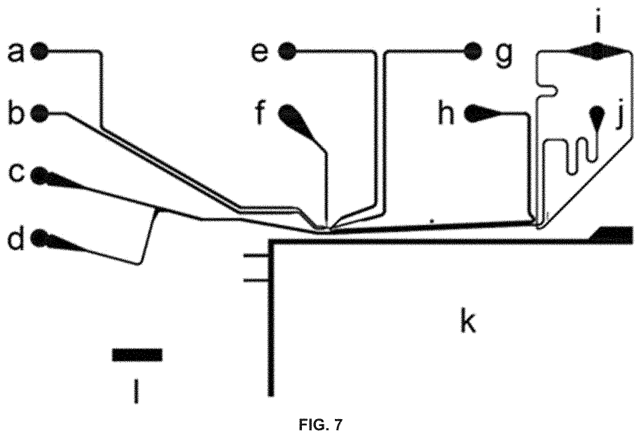

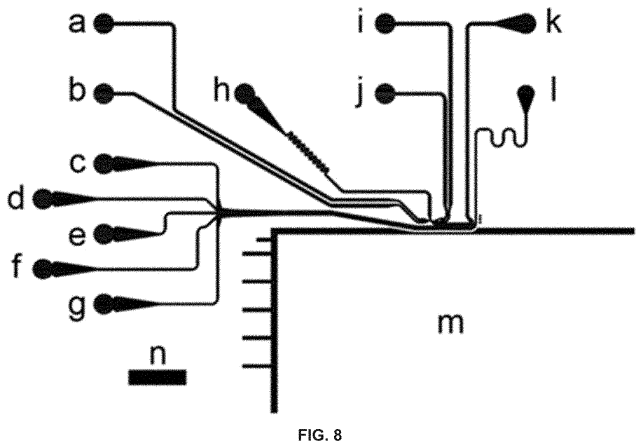

During the development of embodiments of the technology provided herein, microfluidic devices were designed and produced using alternative designs. FIG. 6 shows an embodiment of a microfluidic device, e.g., that is specialized for washing 10-μm magnetic beads. FIG. 7 shows an embodiment of a microfluidic device, e.g., that is specialized for washing 2.8-μm magnetic beads. FIG. 8 shows an embodiment of a microfluidic device, e.g., that is designed to provide multiple washes of beads.

### Multiple Wash Devices

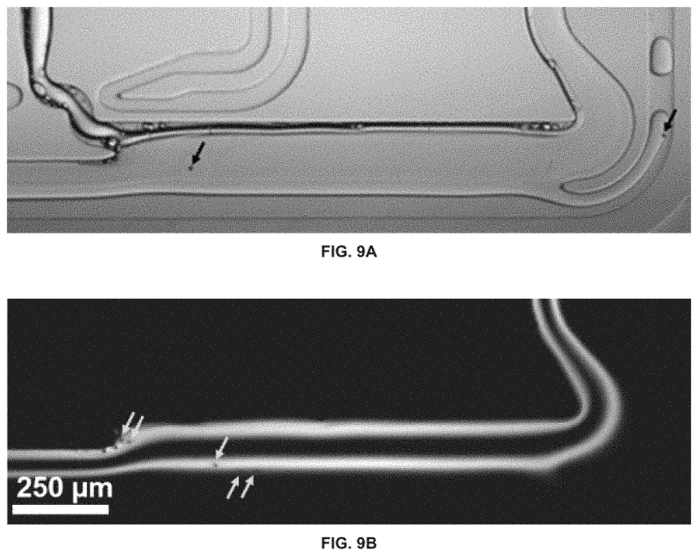

During the development of the technology provided herein, microfluidic washing devices were designed and tested for providing multiple washes of beads. FIG. 8 shows an embodiment of a microfluidic device, e.g., that is designed to provide multiple washes of particles (e.g., 10-μm beads and FIG. 9 provides a micrograph of an embodiment of a multiple wash device. The multiple wash devices comprise multiple washing buffer components in a co-flowing configuration (FIG. 8 and FIG. 9). In particular, the single washing buffer inlet is replaced by a plurality of washing buffer inlets (e.g., in parallel). In the embodiment shown in FIG. 8, the microfluidic device comprises four washing buffer inlets (e.g., components (c) to (f)). However, the technology is not limited in the number of washing buffer inlets and can comprise fewer than four (e.g., 2 or 3) or more than four (e.g., 5, 6, 7, 8, 9, 10, or more).

Embodiments of the multiple washing buffer microfluidic device comprise an oil inlet, e.g., to provide a co-flowing oil stream. In this configuration, microfluidic laminar flow performance maintains boundaries between non-identical washing buffer streams in co-flow and the composition of each buffer stream remains distinct. Therefore, when the microfluidic magnetic bead washing operation attracts beads, each bead passes through a number of flow streams that can each contain a unique buffer. Buffers can vary from each other in terms of chemical component identity and/or concentration.

In some embodiments, droplet resegmentation is performed using one or more of the co-flowing washing buffer flows. In some embodiments, diffusional mixing partly combines two or more of the washing buffers near their co-flowing interface and the extent of the mixing is controlled (e.g., increased or reduced) by the device design.

In some embodiments, the multiple buffer wash microfluidic device is modified to accommodate various magnetic beads.

Embodiments of the device provide advantages relative to previous devices. For example, some useful chemical processes and/or analyses comprise washing magnetic particles multiple times, with repeating or non-repeating washing buffer or reagent flow compositions. Embodiments of the device described herein perform multiple washing in a single microfluidic operation. Performing multiple wash steps in one operation can be advantageous compared to performing many separate microfluidic or manual washing operations to achieve the same result. Some prior technologies have washed magnetic particles or entire magnetic ferrofluid droplets in a similar configuration of multiple co-flowing buffers and reagents, (see, e.g., Alorab et al. (2017) Lab on a Chip 17: 3785-3795; Tarn et al. (2014) Analytical and Bioanalytical Chemistry 406: 139-161, each of which is incorporated herein by reference). In contrast, the technology provided herein combines multiple washing buffers (e.g., in parallel co-flow arrangement) with droplet coalescence, magnetic attraction, and droplet resegmentation as described herein.

### REFERENCES

1. T. Thorsen, R. W. Roberts, F. H. Arnold and S. R. Quake, Physical Review Letters, 2001, 86, 4163-4166.
2. L. Shang, Y. Cheng and Y. Zhao, Chemical Reviews, 2017, 117, 7964-8040.
3. S.-Y. Teh, R. Lin, L.-H. Hung and A. P. Lee, Lab on a Chip, 2008, 8, 198-220.
4. H. Song, J. D. Tice and R. F. Ismagilov, Angewandte Chemie International Edition, 2003, 42, 768-772.
5. J.-C. Baret, Lab on a Chip, 2012, 12, 422-433.
6. N. Habib, I. Avraham-Davidi, A. Basu, T. Burks, K. Shekhar, M. Hofree, S. R. Choudhury, F. Aguet, E. Gelfand, K. Ardlie, D. A. Weitz, O. Rozenblatt-Rosen, F. Zhang and A. Regev, Nature Methods, 2017, 14, 955-958.
7. Y. Xu, J.-H. Lee, Z. Li, L. Wang, T. Ordog and R. C. Bailey, Lab on a Chip, 2018, 18, 2583-2592.
8. R. Obexer, A. Godina, X. Garrabou, P. R. E. Mittl, D. Baker, A. D. Griffiths and D. Hilvert, Nature Chemistry, 2017, 9, 50-56.
9. S. M. Prakadan, A. K. Shalek and D. A. Weitz, Nature Reviews Genetics, 2017, 18, 345-361.
10. Z. Zhu and C. J. Yang, Accounts of Chemical Research, 2017, 50, 22-31.
11. T. Trantidou, M. Friddin, Y. Elani, N. J. Brooks, R. V. Law, J. M. Seddon and O. Ces, ACS Nano, 2017, 11, 6549-6565.
12. M. Serra, D. Ferraro, I. Pereiro, J. L. Viovy and S. Descroix, Lab on a Chip, 2017, 17, 3979-3999.
13. H. Lee, L. Xu and K. W. Oh, Biomicrofluidics, 2014, 8, 044113.
14. A. Munaz, M. J. A. Shiddiky and N.-T. Nguyen, Biomicrofluidics, 2018, 12, 031501.
15. R. Gao, Z. Cheng, A. J. deMello and J. Choo, Lab on a Chip, 2016, 16, 1022-1029.
16. M. A. Booth, S. A. N. Gowers, C. L. Leong, M. L. Rogers, I. C. Samper, A. P. Wickham and M. G. Boutelle, Analytical Chemistry, 2018, 90, 2-18.
17. C. D. M. Campos, S. S. T. Gamage, J. M. Jackson, M. A. Witek, D. S. Park, M. C. Murphy, A. K. Godwin and S. A. Soper, Lab on a Chip, 2018, 18, 3459-3470.
18. V. Sahore, M. Sonker, A. V. Nielsen, R. Knob, S. Kumar and A. T. Woolley, Analytical and Bioanalytical Chemistry, 2018, 410, 933-941.
19. C. A. G. N. Montalbetti and V. Falque, Tetrahedron, 2005, 61, 10827-10852.
20. F. S. Apple and P. O. Collinson, Clinical Chemistry, 2012, 58, 54-61.
21. V. Sahore, S. R. Doonan and R. C. Bailey, Analytical Methods, 2018, 10, 4264-4274.
22. P. Garstecki, M. J. Fuerstman, H. A. Stone and G. M. Whitesides, Lab on a Chip, 2006, 6, 437-446.
23. A. R. Abate, T. Hung, P. Mary, J. J. Agresti and D. A. Weitz, Proceedings of the National Academy of Sciences, 2010, 107, 19163-19166.
24. S. R. Doonan and R. C. Bailey, Analytical Chemistry, 2017, 89, 4091-4099.
25. A. Shams Khorrami and P. Rezai, Soft Matter, 2018, DOI: 10.1039/C8SM02098A.
26. E. Brouzes, T. Kruse, R. Kimmerling and H. H. Strey, Lab on a Chip, 2015, 15, 908-919.
27. B. Verbruggen, K. Leirs, R. Puers and J. Lammertyn, Microfluidics and Nanofluidics, 2015, 18, 293-303.
28. X. Pan, S. Zeng, Q. Zhang, B. Lin and J. Qin, ELECTROPHORESIS, 2011, 32, 3399-3405.
29. D. J. Guckenberger, H. M. Pezzi, M. C. Regier, S. M. Berry, K. Fawcett, K. Barrett and D. J. Beebe, Analytical Chemistry, 2016, 88, 9902-9907.
30. J. Park, G. Destgeer, H. Kim, Y. Cho and H. J. Sung, Lab on a Chip, 2018, 18, 2936-2945.
31. B. Teste, J. Champ, A. Londono-Vallejo, S. Descroix, L. Malaquin, J.-L. Viovy, I. Draskovic and G. Mottet, Lab on a Chip, 2017, 17, 530-537.
32. B. Seale, C. Lam, D. G. Rackus, M. D. Chamberlain, C. Liu and A. R. Wheeler, Analytical Chemistry, 2016, 88, 10223-10230.
33. Y. Xia and G. M. Whitesides, Angewandte Chemie International Edition, 1998, 37, 550-575.
34. A. Sciambi and A. R. Abate, Lab on a Chip, 2014, 14, 2605-2609.
35. A. K. Price, A. B. MacConnell and B. M. Paegel, Analytical chemistry, 2014, 86, 5039-5044.
36. M. T. Chung, D. Nüñez, D. Cai and K. Kurabayashi, Lab on a Chip, 2017, 17, 3664-3671.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

1-38. (canceled)

39. A microfluidic washing device comprising:
a coalescing component configured to coalesce
an input droplet comprising
a magnetic bead; and
input buffer
with a flowing wash buffer;
an attracting component configured to attract magnetic beads; and
an outlet component configured to output said magnetic bead in said wash buffer.

40. The microfluidic device of claim 39 wherein said coalescing component produces an electric potential.

41. The microfluidic device of claim 39 wherein said attraction component comprises a magnet.

42. The microfluidic device of claim 39 wherein said outlet component is configured to reform a droplet comprising said magnetic bead in said wash buffer.

43. The microfluidic device of claim 39 further comprising an oil inlet configured to provide an oil co-flow.

44. The microfluidic device of claim 39 comprising a plurality of wash buffer inlets configured to provide laminarly co-flowing wash buffers.

45. The microfluidic device of claim 39 wherein said coalescing component comprises an electrode at the proximal side of the device and said attracting component comprises a magnet at the distal side of the device.

46. The microfluidic device of claim 39 further comprising an outlet configured to output said input buffer.

47. The microfluidic device of claim 39 wherein said magnetic bead comprises a binding moiety specific for an analyte.

48. A method of washing magnetic beads in a microfluidic device, the method comprising:
coalescing an input droplet comprising a magnetic bead and an input buffer with a flowing wash buffer;
attracting said magnetic bead; and
outputting said magnetic bead in said wash buffer at an outlet of said microfluidic device.

49. The method of claim 48 wherein said coalescing comprises destabilizing said input droplet.

50. The method of claim 48 wherein said coalescing comprises providing an electric potential across said input droplet.

51. The method of claim 48 wherein said attracting said magnetic bead comprises providing a magnetic field.

52. The method of claim 48 wherein said attracting said magnetic bead comprises moving said magnetic bead from a proximal side of the microfluidic device to a distal side of the microfluidic device while the wash buffer flows from an inlet side of the microfluidic device to an outlet side of the microfluidic device.

53. The method of claim 48 comprising providing a plurality of laminarly co-flowing wash buffers and said attracting said magnetic bead comprises moving said magnetic bead across said plurality of laminarly co-flowing wash buffers.

54. The method of claim 48 further comprising reforming a droplet comprising said magnetic bead in said wash buffer at an outlet of said microfluidic device.

55. The method of claim 48 wherein said magnetic bead comprises a binding moiety.

56. The method of claim 48 wherein said wash buffer output at said outlet of said microfluidic device comprises at least 95% of the magnetic beads and/or at least 95% of an analyte present in input droplets provided to said microfluidic device.

57. The method of claim 48 wherein non-analytes in said wash buffer output at said outlet of said microfluidic device are diluted 100-fold to 1000-fold relative to non-analytes present in said input droplets provided to said microfluidic device.

58. The method of claim 48 wherein said microfluidic device processes droplets at greater than 100 Hz.
